(19) United States
(12) Patent Application Publication
(10) Pub. No.: US 2026/0277789 A1
(43) Pub. Date: Sep. 17, 2026

(54) MEMORY SYSTEM AND CONTROL METHOD

(71) Applicant: Kioxia Corporation, Tokyo (JP)

(72) Inventors: Takashi TAKEMOTO, Yokohama (JP); Tomoaki SUZUKI, Chigasaki (JP)

(73) Assignee: Kioxia Corporation, Tokyo (JP)

(21) Appl. No.: 19/237,532

(22) Filed: Jun. 13, 2025

(30) Foreign Application Priority Data
Mar. 14, 2025 (JP) 2025-041489

(51) Int. Cl. G06F 12/02

(52) U.S. Cl. CPC G06F 12/0246; G06F 2212/7211

(57) ABSTRACT

According to one embodiment, a memory system includes a nonvolatile memory and a controller. The controller manages a degree of wear-out of the nonvolatile memory for each wear management unit that includes P access units among access units in the nonvolatile memory, and manages first data into which one or more addresses are converted. The one or more addresses respectively indicate one or more access units accessed among the P access units in a first wear management unit. The controller accesses an access unit in a first wear management unit and converts an address indicating the access unit into second data. The controller makes a determination as to whether there is a possibility that the one or more addresses include the address by using the first and second data.

### CROSS-REFERENCE TO RELATED APPLICATIONS

This application is based upon and claims the benefit of priority from Japanese Patent Application No. 2025-041489, filed Mar. 14, 2025, the entire contents of which are incorporated herein by reference.

### FIELD

Embodiments described herein relate generally to a memory system and a control method.

### BACKGROUND

In recent years, a memory system that includes a nonvolatile memory has been widely used. In the memory system, for example, a life of the nonvolatile memory is presented to a host by managing a degree of wear-out of the nonvolatile memory. Access to the nonvolatile memory is performed by using a storage area of a specific size as a minimum access unit. On the other hand, management of the degree of wear-out of the nonvolatile memory may be performed by using, as a unit (wear management unit), a storage area larger than the minimum access unit.

The degree of wear-out of the wear management unit is represented by, for example, the number of times of access to a corresponding storage area.

Specifically, for example, access to any one of a plurality of minimum access units that are included in the wear management unit is counted as one access to the wear management unit. In such a case, the degree of wear-out of the wear management unit may be higher than an actual degree of wear-out and be pessimistic.

As a method for eliminating the pessimism for the degree of wear-out, there is a method of increasing a degree of wear-out of a wear management unit including an address when duplicate access to the address has been detected by using a history of access (access log) to the nonvolatile memory. In this method, an effect of eliminating the pessimism for the degree of wear-out is improved by increasing the number of entries of the access log, but cost of a process of detecting duplicate access to each address increases.

### BRIEF DESCRIPTION OF THE DRAWINGS

FIG. 1 is a block diagram illustrating a configuration example of an information processing system that includes a memory system according to a first embodiment.

FIG. 2 is a diagram illustrating an example of a management unit of a degree of wear-out in the memory system according to the first embodiment.

FIG. 3 is a diagram illustrating a configuration of an access log used in a memory system according to a comparative example.

FIG. 4 is a flowchart illustrating a procedure of a wear management process executed in the memory system according to the comparative example.

FIG. 5 is a block diagram illustrating a configuration example of a wear management circuit of the memory system according to the first embodiment.

FIG. 6 is a diagram illustrating a configuration example of an access log used in the memory system according to the first embodiment and a first example of address merge in the access log.

FIG. 7 is a diagram illustrating a second example of the address merge in the access log used in the memory system according to the first embodiment.

FIG. 8 is a diagram illustrating an example of an eviction candidate list selected by using the access log, in the memory system according to the first embodiment.

FIG. 9 is a flowchart illustrating an example of a procedure of a wear management process executed in the memory system according to the first embodiment.

FIG. 10 is a flowchart illustrating another example of the procedure of the wear management process executed in the memory system according to the first embodiment.

FIG. 11 is a flowchart illustrating an example of a procedure of an access log management process executed in the memory system according to the first embodiment.

FIG. 12 is a block diagram illustrating a configuration example of a wear management circuit of a memory system according to a second embodiment.

FIG. 13 is a diagram illustrating an example of a bloom filter (BF) bit pattern generated in the memory system according to the second embodiment.

FIG. 14 is a diagram illustrating (a) a configuration example of a BF bit pattern table including a BF bit pattern for each region and (b) a configuration example of a BF bit pattern table including a BF bit pattern for each region group, that are managed in the memory system according to the second embodiment.

FIG. 15 is a diagram illustrating an example of a pseudo code corresponding to the wear management circuit of the memory system according to the second embodiment.

FIG. 16 is a diagram illustrating an example of a gen bf function that generates a BF bit pattern in the pseudo code of FIG. 15.

FIG. 17 is a diagram illustrating an example of an xorshift function that calculates a hash value in the gen bf function of FIG. 16.

FIG. 18 is a block diagram illustrating an example of a circuit configuration of the wear management circuit of the memory system according to the second embodiment.

FIG. 19 is a flowchart illustrating an example of a procedure of a wear management process executed in the memory system according to the second embodiment.

FIG. 20 is a flowchart illustrating another example of the procedure of the wear management process executed in the memory system according to the second embodiment.

FIG. 21 is a block diagram illustrating a configuration example of a wear management circuit of a memory system according to a third embodiment.

FIG. 22 is a diagram illustrating a configuration example of a BF bit pattern table used in the memory system according to the third embodiment.

FIG. 23 is a flowchart illustrating an example of a procedure of a wear management process executed in the memory system according to the third embodiment.

FIG. 24 is a flowchart illustrating another example of the procedure of the wear management process executed in the memory system according to the third embodiment.

### DETAILED DESCRIPTION

In general, according to one embodiment, a memory system includes a nonvolatile memory and a controller. The nonvolatile memory includes a plurality of access units. The controller is electrically connected to the nonvolatile memory. The controller performs access to the nonvolatile memory for each access unit. The controller manages a degree of wear-out of the nonvolatile memory for each wear management unit that includes P access units among the plurality of access units. The controller manages Q pieces of first data that correspond to Q wear management units, respectively. The first data is data into which one or more addresses are converted. The one or more addresses respectively indicate one or more access units accessed among the P access units in each of the Q wear management units. The controller accesses a first access unit among the P access units that are included in a first wear management unit among the Q wear management units. The controller converts a first address indicative of the first access unit into second data. The controller makes a first determination as to whether there is a possibility that the first address is included in the one or more addresses converted into the first data corresponding to the first wear management unit among the managed Q pieces of first data by using the first data corresponding to the first wear management unit and the second data. The controller determines whether or not to increase a degree of wear-out of the first wear management unit, based on a result of the first determination. A bit length of the first data is same as a bit length of the second data. P is an integer of two or more. Q is an integer of one or more.

Various embodiments will be described hereinafter with reference to the accompanying drawings.

### First Embodiment

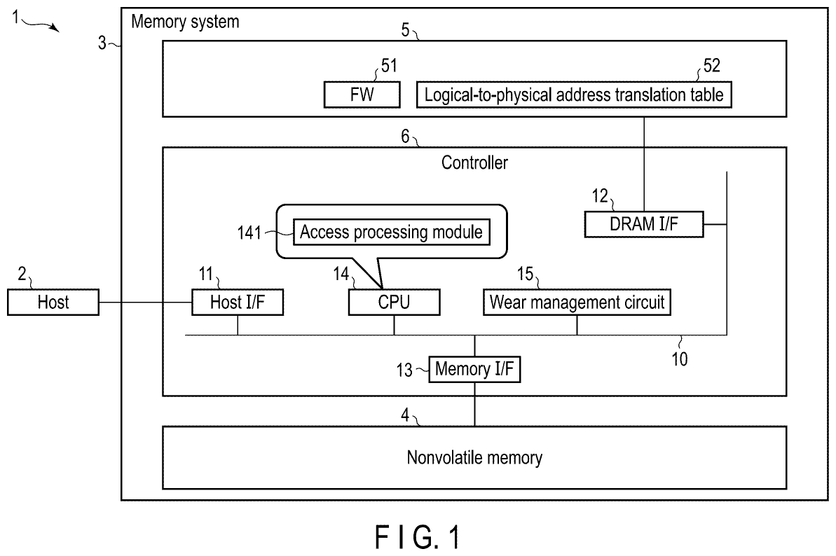

First, a configuration of an information processing system 1 that includes a memory system according to a first embodiment will be described with reference to FIG. 1. The information processing system 1 includes a host 2 and a memory system 3.

The host 2 may be a storage server that stores a large amount of various data in the memory system 3, or may be a personal computer. The host 2 is also referred to as a host device.

The memory system 3 is a storage device configured to write data to a nonvolatile memory 4 and read data from the nonvolatile memory 4. The memory system 3 is also referred to as a storage device or a semiconductor storage device. The nonvolatile memory 4 is, for example, a storage class memory (SCM). The SCM is, for example, a cross-point type memory, a magnetoresistive random access memory (MRAM), a phase change random access memory (PRAM), a resistive random access memory (ReRAM), or a ferroelectric random access memory (FeRAM). The nonvolatile memory 4 may be a NAND flash memory including memory cells having a two-dimensional structure or a three-dimensional structure.

The memory system 3 may be used as a storage of the host 2. The memory system 3 may be provided inside the host 2 or may be connected to the host 2 via a cable or a network.

An interface for connecting the host 2 and the memory system 3 conforms to standards such as PCI (PCIe™), Ethernet™, Fibre channel, NVM Express™ Express™ (NVMe™), or Compute Express Link™ (CXL™).

The memory system 3 includes, for example, the nonvolatile memory 4, a dynamic random access memory (DRAM) 5, and a controller 6.

The DRAM 5 is a volatile memory. A storage area of the DRAM 5 is allocated as, for example, a storage area of firmware (FW) 51 and a cache area of a logical-to-physical address translation table 52. The storage area of the DRAM 5 may be further allocated as a buffer area that temporarily stores user data.

The FW 51 is a program for controlling an operation of the controller 6. The FW 51 is loaded from the nonvolatile memory 4 to the DRAM 5, for example.

The logical-to-physical address translation table 52 is a table for managing mapping between each logical address and each physical address. The logical address is an address used by the host 2 for addressing a storage area of the memory system 3. The logical address is, for example, a logical block address (LBA). The physical address is an address by which a storage location in the nonvolatile memory 4 is identifiable.

The controller 6 is a memory controller configured to control the nonvolatile memory 4. The controller 6 may be implemented with a semiconductor chip such as a System-on-a-Chip (SoC). The controller 6 may be implemented with a plurality of semiconductor chips. The controller 6 is electrically connected to the nonvolatile memory 4. A function of each unit of the controller 6 may be realized by dedicated hardware in the controller 6 or may be realized by a processor executing the FW 51.

The controller 6 may function as a flash translation layer (FTL) configured to execute data management of the nonvolatile memory 4. The data management executed by the FTL includes management of mapping information indicative of a relationship between each logical address and each physical address.

The management of mapping between each logical address and each physical address is executed by using, for example, the logical-to-physical address translation table 52. The controller 6 uses the logical-to-physical address translation table 52 to manage the mapping between each logical address and each physical address in a certain management size. A physical address corresponding to a logical address indicates a physical memory location in the nonvolatile memory 4 in which data of the logical address is stored. The controller 6 manages, by using the logical-to-physical address translation table 52, a plurality of storage areas that are obtained by logically dividing the storage area of the nonvolatile memory 4. The size of each of the plurality of storage areas is the management size described above. The plurality of storage areas correspond to a plurality of logical addresses, respectively. That is, each of the plurality of storage areas is identified by one logical address. The logical-to-physical address translation table 52 may be loaded from the nonvolatile memory 4 to the DRAM 5 when the memory system 3 is boot up.

The controller 6 includes, for example, a host interface circuit (host I/F) 11, a DRAM interface circuit (DRAM I/F) 12, a memory interface circuit (memory I/F) 13, a central processing unit (CPU) 14, and a wear management circuit 15. The host I/F 11, the DRAM I/F 12, the memory I/F 13, the CPU 14, and the wear management circuit 15 are electrically connected, for example, via a bus 10.

The host I/F 11 is a circuit configured to receive various commands (for example, an input/output (I/O) command and a control command) and data from the host 2 and transmit a response to a command and data to the host 2. The I/O command is, for example, an access command such as a write command or a read command. The write command is a command to write user data to a designated logical address. The read command is a command to read user data from a designated logical address. The control command includes, for example, an unmap command (trim command). The unmap command is a command to invalidate data corresponding to a designated logical address (or logical address range).

The DRAM I/F 12 is a DRAM control circuit configured to control access to the DRAM 5.

The memory I/F 13 is a memory control circuit configured to control the nonvolatile memory 4. The memory I/F 13 may be connected to a plurality of memory chips in the nonvolatile memory 4 via a plurality of channels. By operating the plurality of memory chips in parallel, it is possible to broaden an access bandwidth between the controller 6 and the nonvolatile memory 4.

The memory I/F 13 electrically connects the controller 6 and the nonvolatile memory 4. In a case where the nonvolatile memory 4 is a NAND flash memory, the memory I/F 13 conforms to an interface standard such as a Toggle Double Data Rate (Toggle DDR) or an Open NAND Flash Interface (ONFI).

The CPU 14 is a processor configured to control the host I/F 11, the DRAM I/F 12, the memory I/F 13, and the wear management circuit 15. The CPU 14 performs various processes by executing the FW 51 loaded from the nonvolatile memory 4 to the DRAM 5. The FW 51 is a control program including instructions for causing the CPU 14 to execute the various processes. The CPU 14 may perform command processes to execute various commands from the host 2. The operation of the CPU 14 is controlled by the FW 51 executed by the CPU 14.

The CPU 14 functions as, for example, an access processing module 141. The CPU 14 functions as the access processing module 141 by executing the FW 51, for example.

The access processing module 141 executes a process for accessing the nonvolatile memory 4 (hereinafter, also referred to as an access process).

The access process includes, for example, a process of accessing the nonvolatile memory 4 in accordance with an access command received from the host 2. The access processing module 141 accesses a certain access unit included in the nonvolatile memory 4 via the memory I/F 13. Specifically, for example, the access processing module 141 writes data to the certain access unit via the memory I/F 13. The access processing module 141 reads data from the certain access unit via the memory I/F 13.

The access processing module 141 sends information indicative of a storage location in the nonvolatile memory 4 to be accessed, to the wear management circuit 15. Specifically, the access processing module 141 sends, for example, access information indicative of a storage location in the nonvolatile memory 4 in which data is to be written, to the wear management circuit 15. The access processing module 141 may further send access information indicative of a storage location in the nonvolatile memory 4 from which data is to be read, to the wear management circuit 15. The information indicative of a storage location in the nonvolatile memory 4 to be accessed is also referred to as access information. The access information is, for example, an address by which a storage location (for example, an access unit) to be accessed is uniquely identifiable.

The wear management circuit 15 is a circuit for managing a degree of wear-out of the nonvolatile memory 4. Specifically, the wear management circuit 15 manages the degree of wear-out of the nonvolatile memory 4 for each specific unit by using the access information received from the access processing module 141 and an access log that indicates a history of previously accessed addresses. The specific unit whose degree of wear-out is managed is also referred to as a wear management unit.

The SCM used as the nonvolatile memory 4 is a memory positioned between a main memory such as a DRAM and a storage such as a NAND flash memory. Depending on memory characteristics, the SCM is considered to have a speed, a cost, and a life that are intermediate between those of the DRAM and those of the NAND flash memory. That is, in the SCM, the number of times of access is not substantially unlimited unlike the DRAM, and management for measuring the degree of wear-out is required.

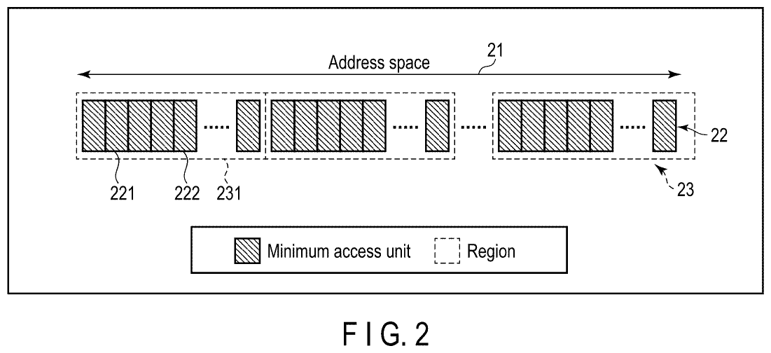

FIG. 2 illustrates an example of wear management units in the wear management circuit 15. An address space 21 of the nonvolatile memory 4 managed in the memory system 3 includes a plurality of access units 22.

The plurality of access units 22 each function as, for example, a minimum unit (minimum granularity) of a data write operation and a data read operation. Each of the access units 22 has a size of, for example, a several ten bytes (B).

If the access units 22 are set as wear management units, respectively, a data amount of a management table for managing degrees of wear-out of the wear management units becomes enormous. Therefore, the degrees of wear-out may be managed by using, as a wear management unit, a storage area that is larger than an access unit 22. Note that the degree of wear-out of a wear management unit is represented by, for example, the number of times of access to any of addresses that are included in the wear management unit.

The storage area that is used as a wear management unit and is larger than an access unit 22 is referred to as a region 23. The degree of wear-out managed in units of the region 23 is also referred to as the degree of wear-out per region. The region 23 includes P access units 22. P is, for example, an integer of two or more. The P access units 22 correspond to, for example, contiguous addresses in the address space 21. The region 23 has a size of, for example, several hundred kilobytes (KB) to several megabytes (MB). The address space 21 includes Q regions 23. Q is, for example, an integer of one or more.

In a case where the degree of wear-out per region is managed, for example, the degree of wear-out of a region 23 is incremented (increased) in response to access to any address in the region 23. Specifically, for example, when access to an address indicative of an access unit 221 and access to an address indicative of an access unit 222 have been performed in a region 231, the degree of wear-out of the region 231 is incremented twice. Thus, in accordance with access to different addresses in the region 23, the degree of wear-out of the region 23 is incremented by the number of these addresses. Therefore, the degree of wear-out per region is likely to be more pessimistic than the actual degree of wear-out of each access unit 22. That is, the degree of wear-out of the region 23 is likely to be higher than the degree of wear-out of any access unit 22 included in the region 23.

In this case, a presented life of the memory system 3 may be significantly reduced. The presented life indicates the degree of deterioration of the nonvolatile memory 4 that is presented to the outside (for example, the host 2) by the memory system 3. The presented life is represented by, for example, a value from 0% to 100%, and the larger the value, the more the deterioration progresses. In a case where the presented life of the memory system 3 is 100%, the host 2 determines that the nonvolatile memory 4 has reached the end of life thereof.

An example of a method of reducing the pessimism for the degree of wear-out per region is a method of using an access log with a finite length.

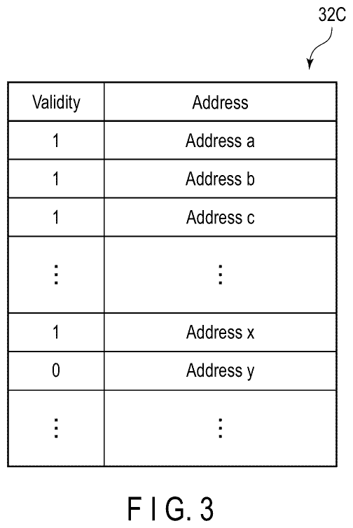

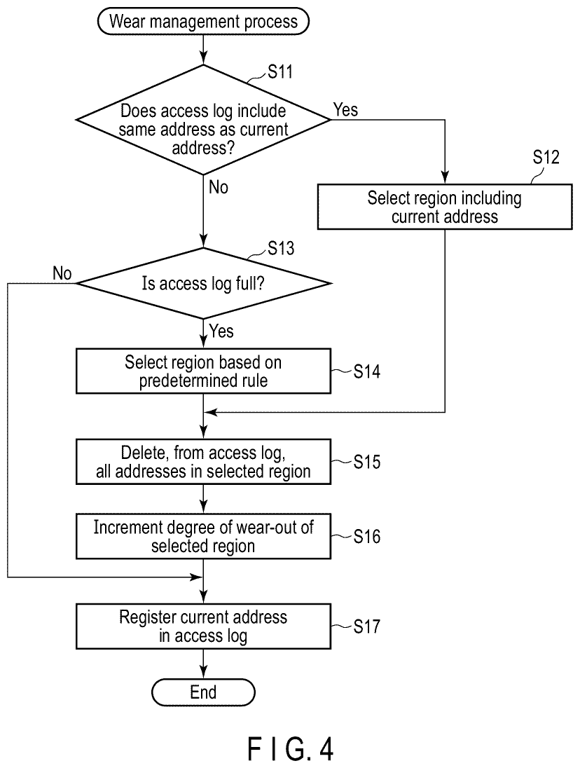

With reference to FIGS. 3 and 4, a memory system according to a comparative example that reduces the pessimism for the degree of wear-out per region by using the access log with the finite length will be described. The memory system according to the comparative example is referred to as a memory system 3C. When access to an address that is duplicate (hereinafter, also referred to as duplicate access) has been detected, the memory system 3C increments the degree of wear-out of a region 23 that includes the address. As a result, in the memory system 3C, the pessimism for the degree of wear-out per region is reduced.

FIG. 3 illustrates a configuration of an access log 32C used in the memory system 3C of the comparative example. The access log 32C is data that indicates a history of previously accessed addresses. The access log 32C is used to determine whether or not a newly accessed address (hereinafter, also referred to as a current address) matches any previously accessed address in the access log 32C. The access log 32C has a finite length. That is, there is an upper limit to the number of entries (maximum number of entries) that can be stored in the access log 32C. The access log 32C includes a plurality of entries that correspond to a plurality of addresses, respectively. Each of the plurality of entries includes a validity field and an address field.

In an entry corresponding to an address, the validity field indicates whether or not the entry is valid. In a case where the entry is valid, “1” is set in the validity field. An entry in which “1” is set in the validity field represents an entry registered in the access log 32C (that is, a valid entry). By contrast, in a case where the entry is invalid, “0” is set in the validity field. An entry in which “0” is set in the validity field represents an entry deleted from the access log 32C (that is, an invalid entry).

The address field indicates the corresponding address. The address set in the address field is a previously accessed address.

In a case where access to an address is to be performed, the access log 32C is updated to set “1” in the validity field of the entry in which the address is set in the address field.

FIG. 4 is a flowchart illustrating a procedure of a wear management process executed in the memory system 3C of the comparative example. The wear management process is a process for managing the degree of wear-out of each region 23. The memory system 3C executes the wear management process in response to access to the current address.

First, the memory system 3C determines whether or not the same address as the current address exists in the access log 32C (S11). Specifically, the memory system 3C determines whether or not the access log 32C includes a valid entry in which the current address is set. When the access log 32C includes the valid entry in which the current address is set, the memory system 3C determines that the same address as the current address exists in the access log 32C. When the access log 32C includes no valid entry in which the current address is set and when the access log 32C includes an invalid entry in which the current address is set, the memory system 3C determines that the same address as the current address does not exist in the access log 32C.

In a case where the same address as the current address exists in the access log 32C (Yes in S11), the memory system 3C selects a region 23 including the current address (S12), and proceeds to S15.

In a case where the same address as the current address does not exist in the access log 32C (No in S11), the memory system 3C determines whether or not the access log 32C is full (S13). That is, the memory system 3C determines whether or not the number of valid entries included in the access log 32C has reached the maximum number of entries that can be stored in the access log 32C.

In a case where the access log 32C is not full (No in S13), the memory system 3C registers the current address in the access log 32C (S17).

Specifically, in any invalid entry in the access log 32C, the memory system 3C sets “1” in the validity field and sets the current address in the address field. Then, the memory system 3C ends the wear management process.

In a case where the access log 32C is full (Yes in S13), the memory system 3C selects a region 23 based on a predetermined rule (S14). Specifically, the memory system 3C selects a region 23 from one or more regions 23 each including at least one of the addresses set in respective valid entries in the access log 32C, on the basis of the specific rule. The predetermined rule is, for example, a rule of selecting a region 23 that includes the least recently used (LRU) address in the access log 32C. Then, the process executed by the memory system 3C proceeds to S15.

Next, the memory system 3C deletes, from the access log 32C, all addresses that are included in the region 23 selected in S12 or S13 (S15). Specifically, the memory system 3C identifies, in the access log 32C, all valid entries in which any of the addresses included in the selected region 23 is set. The memory system 3C sets “0” in the validity field of each of the identified valid entries. As a result, all the valid entries in which any of the addresses included in the selected region 23 is set become invalid entries. This corresponds to deletion of all the addresses in the selected region 23 from the access log 32C. The memory system 3C increments the degree of wear-out of the selected region 23 (S16). Then, the memory system 3C registers the current address in the access log 32C (S17), and ends the wear management process.

With the wear management process described above, the memory system 3C of the comparative example increments the degree of wear-out of the region 23 including the current address in a case where any previously accessed address in the access log 32C matches the current address, that is, in a case where the access to the current address is duplicate access. In this manner, by counting the degree of wear-out (for example, the number of times of access) per region on the basis of the matching between any previously accessed address and the current address, the memory system 3C can reduce the pessimism for the degree of wear-out per region.

However, the wear management process in the memory system 3C of the comparative example is high in processing cost. For example, it is difficult to execute the wear management process of the comparative example with performance of G accesses/second (G addresses/second) required in a case of conforming to the standard of CXL3.0. Specifically, it is difficult to execute (1) a process of detecting a previously accessed address that matches the current address from the access log 32C and selecting a region 23 including the matching address, (2) a process of selecting a region 23 based on the predetermined rule in a case where the access log 32C is full, and (3) a process of invalidating, in the access log 32C, all valid entries that each indicate any of addresses included in the selected region 23, within a period in which one access is performed.

As a method of shortening a time required for the wear management process, it is conceivable to implement the access log 32C with flip-flop circuits (F/F circuits) instead of a static random access memory (SRAM). By implementing the access log 32C with the F/F circuits, it is possible to access the plurality of entries in the access log 32C in parallel. Therefore, it is possible to shorten a time required for accessing the access log 32C in the wear management process.

However, in the case where the access log 32C is implemented with the F/F circuits, the maximum number of entries of the access log 32C has an upper limit according to processing performance required for the memory system 3C. The maximum number of entries is, for example, about 64. Then, in a case where the maximum number of entries of the access log 32C is small and distributed access across the regions 23 are requested, an effect of reducing the pessimism for the degree of wear-out per region by the wear management process of the comparative example is greatly reduced. In such a case, an improvement rate of the presented life is about 64/the number of simultaneous access regions.

Note that the distributed access across the regions 23 may occur, for example, in random accesses or in access with a multi-stream function. The multi-stream function is a function of receiving a write request (for example, a write command) associated with a stream among a plurality of streams from a host and writing data associated with the write request to a storage area of a nonvolatile memory that is allocated to the stream. That is, a memory system having the multi-stream function switches a storage area of a write destination for each stream. Therefore, the access with the multi-stream function may become distributed access across the regions 23.

As described above, in the memory system 3C of the comparative example, each entry of the access log 32C indicates one address.

In contrast, in the memory system 3 according to the first embodiment, each entry of the access log is configured to be able to represent a plurality of adjacent addresses. Therefore, even in a case where the maximum number of entries of the access log is limited, the access log can include information indicative of addresses more than the maximum number of entries. As a result, as compared with the memory system 3C of the comparative example, the memory system 3 of the first embodiment can improve the effect of reducing the pessimism for the degree of wear-out per region by using the access log, and can maintain the processing performance by not increasing the maximum number of entries of the access log.

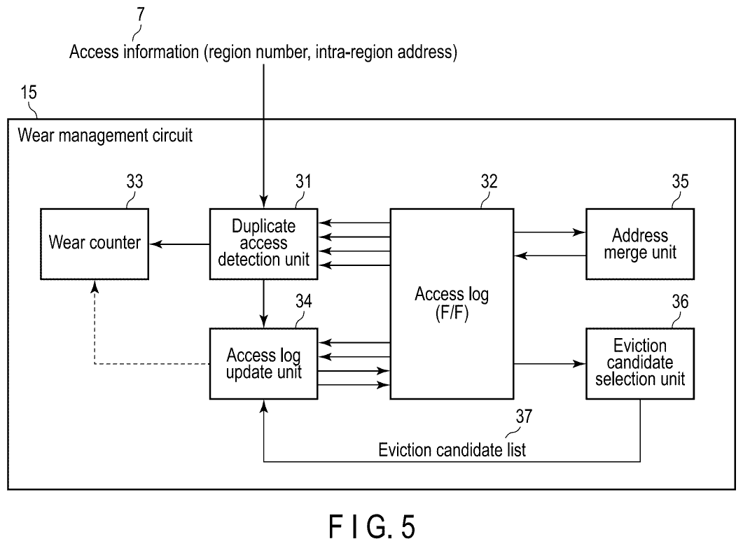

FIG. 5 is a block diagram illustrating a configuration example of the wear management circuit 15 of the memory system 3. In response to access to the nonvolatile memory 4, information 7 regarding the access (hereinafter, also referred to as access information 7) is input to the wear management circuit 15.

The access information 7 includes, for example, a region number and an intra-region address. The region number is information by which a region 23 that includes a storage area to be accessed (current address) is uniquely identifiable. Hereinafter, the region 23 that includes the current address is also referred to as a current region 23. The intra-region address is information indicative of a location of the storage area to be accessed in the current region 23. Hereinafter, a combination of the region number and the intra-region address is also referred to as an address.

The wear management circuit 15 includes, for example, a duplicate access detection unit 31, an access log 32, a wear counter 33 for each region, an access log update unit 34, an address merge unit 35, and an eviction candidate selection unit 36.

The duplicate access detection unit 31 makes a determination as to whether or not a current access corresponding to the access information 7 is duplicate access on the basis of the access information 7 and the access log 32. Specifically, the duplicate access detection unit 31 compares an address based on the access information 7 (i.e., the current address) with each of one or more addresses indicated in the access log 32 (more particularly, valid entries in the access log 32) in parallel, thereby determining whether or not the access log 32 includes the same address as the current address. In a case where the access log 32 includes the same address as the current address, the duplicate access detection unit 31 determines that the current access is duplicate access. In a case where the access log 32 does not include the same address as the current address, the duplicate access detection unit 31 determines that the current access is not duplicate access.

On the basis of a result of the determination, the duplicate access detection unit 31 determines whether or not to increase the degree of wear-out of the current region 23. In the case where the current access is duplicate access, the duplicate access detection unit 31 sends an instruction to increment the degree of wear-out of the current region 23 (increment instruction) to the wear counter 33. The degree of wear-out is represented by, for example, the number of times of access. The increment of the degree of wear-out means that the degree of wear-out is increased by a constant value. The constant value is, for example, one. Then, the duplicate access detection unit 31 sends the determination result for duplicate access and the access information 7 to the access log update unit 34.

In the case where the current access is not duplicate access, the duplicate access detection unit 31 may further determine whether or not the access log 32 includes a valid entry indicative of the same region 23 as the current region 23 (more specifically, the same region number as that of the current region 23). In a case where the access log 32 includes no valid entry indicative of the same region 23 as the current region 23, the duplicate access detection unit 31 may send the increment instruction for the degree of wear-out of the current region 23 to the wear counter 33.

The access log 32 is data that indicates a history of a maximum of N previously accessed addresses. N is an integer of one or more and has an upper limit based on the processing performance required for the memory system 3. N is, for example, 64. In other words, the access log 32 has a finite length, and the number N of entries that can be stored in the access log 32 (the maximum number N of entries) has the upper limit.

The access log 32 is implemented with, for example, F/F circuits (registers). That is, a bit string that indicates each of one or more addresses included in the access log 32 is stored in the F/F circuits. This is because the duplicate access detection unit 31 compares the current address with each of the one or more addresses, which are included in the access log 32, in parallel.

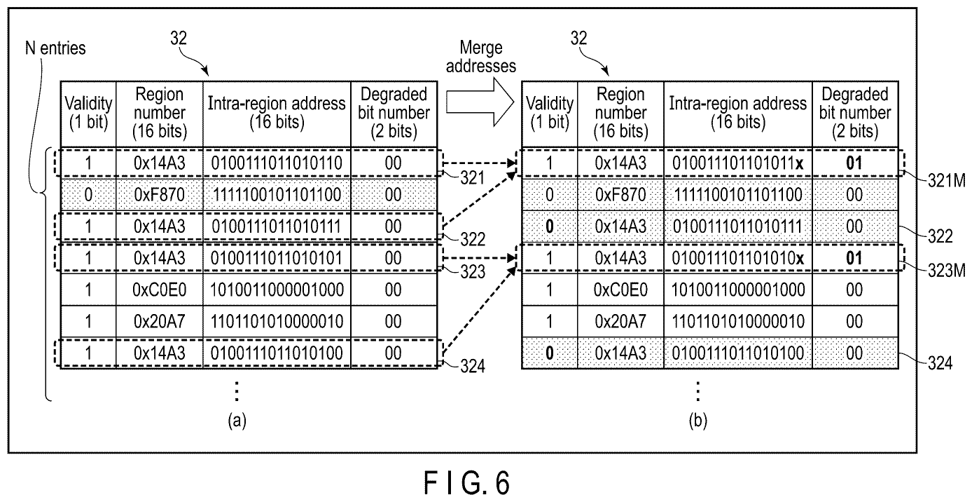

Specifically, in the access log 32, in a case where S access units 22 among the plurality of access units 22 included in the nonvolatile memory 4 have been accessed, S addresses that indicates these S access units 22, respectively, are managed. S is, for example, an integer of one or more. The S addresses are different addresses. A specific configuration example of the access log 32 is described below with reference to FIG. 6.

The wear counter 33 is a counter that stores the degree of wear-out of a corresponding region 23. In an initial state in which the use of the memory system 3 is started, the wear counter 33 stores, for example, 0 as the degree of wear-out of the corresponding region 23. Then, in response to an increment instruction from the duplicate access detection unit 31, the degree of wear-out stored in the wear counter 33 of the corresponding region 23 is incremented.

The access log update unit 34 updates the access log 32 by using the determination result for duplicate access and the access information 7 received from the duplicate access detection unit 31. Specifically, in a case where the determination result for duplicate access indicates that the current access is duplicate access, the access log update unit 34 deletes, from the access log 32, all entries that each indicate any of addresses in the current region 23. That is, the access log update unit 34 invalidates, in the access log 32, all valid entries that each indicate any of the addresses in the current region 23. Then, the access log update unit 34 registers an entry indicative of the access information 7 (current address), in the access log 32. On the other hand, in a case where the determination result for duplicate access indicates that the current access is not duplicate access, the access log update unit 34 registers the entry indicative of the access information 7, in the access log 32.

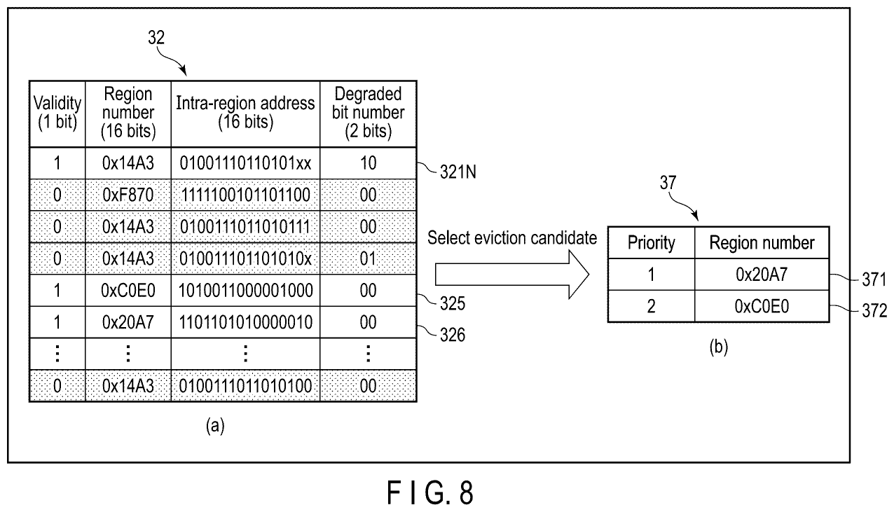

Note that in a case where the access log 32 is full, the access log update unit 34 determines a region 23 to be evicted from the access log 32 (hereinafter, also referred to as an eviction target region 23) by using an eviction candidate list 37. The eviction candidate list 37 is a list indicative of one or more candidates of the regions 23 to be evicted from the access log 32 (hereinafter, also referred to as eviction candidate regions 23). A specific configuration example of the eviction candidate list 37 is described below with reference to FIG. 8. The access log update unit 34 deletes, from the access log 32, all entries that each indicate any of addresses included in the eviction target region 23. That is, the access log update unit 34 invalidates, in the access log 32, all valid entries that each indicate any of addresses included in the eviction target region 23. The access log update unit 34 may send an increment instruction for the degree of wear-out of the eviction target region 23 to the wear counter 33.

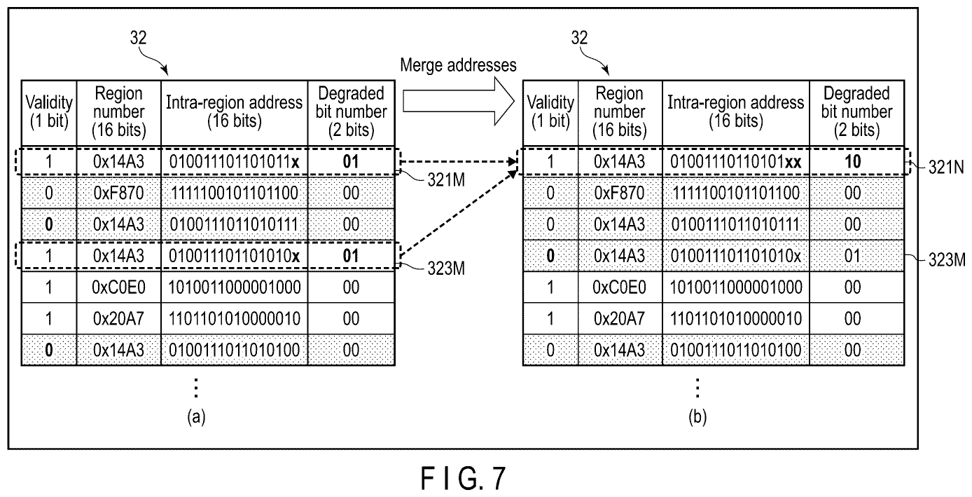

The address merge unit 35 merges (integrates) 2^{T} addresses in the access log 32 that are included in one region 23 and are adjacent. T is any integer between one and a threshold inclusive. The threshold is, for example, three. Specifically, in a case where the access log 32 includes 2^{T} valid entries that respectively indicate 2^{T} addresses that are included in one region 23 and are adjacent, the address merge unit 35 determines an address represented by compressing the 2^{T} addresses (more specifically, the intra-region addresses). Hereinafter, the address represented by compressing the 2^{T} addresses is also referred to as a compressed address. The compressed address is represented by a bit string in which T bits are degraded from the least significant bit of a bit string that indicates any one of the 2^{T} addresses. The bit length of the compressed address is the same as the bit length of each of the 2^{T} addresses before compression. That is, the bit length of the compressed address is maintained at the bit length of each of the 2T addresses before compression. In the compressed address, the degraded T bits from the least significant bit are invalid bits (that is, bits that are not used for the determination of duplicate access). Any value is set in each of the degraded T bits from the least significant bit. That is, the compressed address is a bit string that includes the degraded T bits from the least significant bit. Note that the compressed address may be a bit string that does not include the degraded T bits from the least significant bit. In this case, the bit length of the compressed address is shorter by T bits than the bit length of each of the 2T addresses before compression. The address merge unit 35 merges the 21 valid entries into any one of the 2T valid entries and invalidates the remaining entries of the 21 valid entries. The entry into which the 2T valid entries are merged indicates the compressed address to represent the adjacent 2^{T} addresses. A specific operation of the address merge unit 35 is described below with reference to FIGS. 6 and 7.

As an example, a case where S addresses (S valid entries) are managed in the access log 32, and the S addresses includes 2^{T} addresses that are included in one region 23 and are adjacent will be explained. In this case, S is an integer of two or more. In the access log 32, the 2^{T} addresses are merged, and thereby managing (S−2^{T}+1) addresses that includes one compressed address and (S−2^{T}) addresses obtained by excluding the 2^{T} addresses from the S addresses.

In this case, the duplicate access detection unit 31 makes a determination as to whether or not the S addresses include the current address by using the (S−2^{T}+1) addresses indicated in the access log 32.

Note that in a case where the compressed address is represented by a bit string in which T bits are degraded from the least significant bit, the duplicate access detection unit 31 determines whether or not the current address and the compressed address are the same address by, for example, comparing a bit string in which T bits are excluded from the least significant bit of the bit string of the current address with the bit string in which the T bits are excluded from the least significant bit of the bit string of the compressed address. Alternatively, the duplicate access detection unit 31 may directly compare the bit string of the current address with the bit string of the compressed address. In this case, the duplicate access detection unit 31 handles a part of the comparison result that corresponds to the T bits from the least significant bit as a portion unrelated to the determination as to whether or not the current address and the compressed address are the same address, and determines whether or not the current address and the compressed address are the same address. That is, the duplicate access detection unit 31 handles the T bits from the least significant bit as bits unrelated to the determination as to whether or not the current address and the compressed address are the same address. In a case where the bit length of the compressed address is shorter by T bits than the bit length of the current address, the duplicate access detection unit 31 determines whether or not the current address and the compressed address are the same address by comparing the bit string in which the T bits are excluded from the least significant bit of the bit string of the current address with the bit string of the compressed address. On the basis of the determination result, the duplicate access detection unit 31 determines whether or not to increase the degree of wear-out of the current region 23. That is, in a case where the S addresses include the current address, the duplicate access detection unit 31 sends an increment instruction for the degree of wear-out of the current region 23 to the wear counter 33. In a case where the S addresses do not include the current address, the duplicate access detection unit 31 does not send any increment instruction for the degree of wear-out of the current region 23 to the wear counter 33.

Furthermore, in the case where the S addresses include the current address (that is, in a case where the current access is duplicate access), the access log update unit 34 updates the access log 32 so as to manage: addresses that are obtained by excluding all addresses included in the current region 23 from the (S−2^{T}+1) addresses; and the current address. In the case where the S addresses do not include the current address, the access log update unit 34 updates the access log 32 so as to manage the (S−2^{T}+1) addresses and the current address.

In a case where the S addresses (S valid entries) are managed in the access log 32, and the S addresses do not include 2^{T} addresses that are included in one region 23 and are adjacent (that is, in a case where addresses are not merged), the duplicate access detection unit 31 makes a determination as to whether or not the S addresses include the current address by using the S addresses indicated in the access log 32.

The eviction candidate selection unit 36 selects one or more eviction candidate regions 23 from the access log 32 according to a specific rule. The specific rule is, for example, a rule of preferentially selecting the least recently used (LRU) region 23. The eviction candidate selection unit 36 generates the eviction candidate list 37 that indicates the one or more selected eviction candidate regions 23. The eviction candidate selection unit 36 sends the generated eviction candidate list 37 to the access log update unit 34. A specific operation of the eviction candidate selection unit 36 is described below with reference to FIG. 8.

Note that the processes executed by the address merge unit 35 and the eviction candidate selection unit 36 are performed in a background asynchronously with the processes executed by the duplicate access detection unit 31 and the access log update unit 34 in response to the input of the access information 7. Both or any one of the processes executed by the address merge unit 35 and the eviction candidate selection unit 36 may be executed asynchronously. The process executed by the address merge unit 35 includes, for example, a process for merging 2^{T} addresses into one compressed address. The process executed by the eviction candidate selection unit 36 includes, for example, a process for generating the eviction candidate list 37. The process executed by the duplicate access detection unit 31 includes, for example, a process of determining whether or not access to the current address is duplicate access on the basis of the access log 32 and according to the result of the determination, determining whether or not to increase the wear counter 33. The process executed by the access log update unit 34 includes, for example, a process of updating the access log 32 by using the access information 7 and a process of deleting, from the access log 32 that is full, all entries that each indicate any of addresses included in the eviction target region 23.

The processes executed by the address merge unit 35 and the eviction candidate selection unit 36 are executed, for example, at regular time intervals or in a case where the access log 32 is not in a busy state. As a result, it is possible to avoid the processes executed by the address merge unit 35 and the eviction candidate selection unit 36 from becoming a bottleneck of the processing performance of the memory system 3. Note that the processes executed by the address merge unit 35 and the eviction candidate selection unit 36 may be delayed relative to the processes executed by the duplicate access detection unit 31 and the access log update unit 34, but no malfunction occurs.

Here, a configuration of the access log 32 and merge of adjacent addresses by the address merge unit 35 will be described with reference to FIGS. 6 and 7.

FIG. 6 illustrates a configuration example of the access log 32 and a first example of address merge in the access log 32. The access log 32 includes a maximum of N entries. The N entries may correspond to N addresses, respectively. More specifically, the N addresses are N combinations of a region number and an intra-region address. Each of the N addresses is either an address indicative of one access unit 22 (hereinafter, also referred to as an uncompressed address) or a compressed address. The compressed address is an address represented by compressing 2^{T} addresses that indicate adjacent 2^{T} access units 22, respectively. Each of the N entries includes, for example, a validity field, a region number field, an intra-region address field, and a degraded bit number field.

In an entry corresponding to an address, the validity field indicates whether or not the entry is valid. The bit length of the validity field is, for example, 1 bit.

In a case where the entry is valid, a valid bit is set in the validity field. The valid bit is, for example, “1”. An entry in which the valid bit is set in the validity field is regarded as an entry registered in the access log 32 (i.e., valid entry).

The valid entry is a target entry on which the process of detecting the presence or absence of a possibility of duplicate access on the basis of the access information 7 is performed.

On the other hand, in a case where the entry is invalid, an invalid bit is set in the validity field. The invalid bit is, for example, “0”. An entry in which the invalid bit is set in the validity field is regarded as an entry deleted from the access log 32 (i.e., invalid entry). The invalid entry is not a target entry on which the process of detecting the presence or absence of the possibility of duplicate access on the basis of the access information 7 is performed. Note that in the access log 32, entries illustrated with dot patterns represent invalid entries.

The region number field indicates a region number of the corresponding address. The bit length of the region number field is, for example, 16 bits.

The intra-region address field indicates the intra-region address of the corresponding address. The bit length of the intra-region address field is, for example, 16 bits. Specifically, in the case of indicating an intra-region address of an uncompressed address, the intra-region address field indicates the intra-region address at it is. In the case of indicating an intra-region address of a compressed address, the intra-region address field indicates an address in which a portion common to 21 compressed intra-region addresses is expressed and T bits are degraded from the least significant bit. The degraded T bits from the least significant bit are bits that are not used for comparison with the current address based on the access information 7 (that is, bits unrelated to comparison). Each of the degraded T bits from the least significant bit may indicate any value, for example.

The degraded bit number field indicates the number T of bits degraded in the corresponding address. The bit length of the degraded bit number field is, for example, 2 bits. In this case, any integer from zero to three is set in the degraded bit number field.

Specifically, in a case where the corresponding address is not degraded, for example, “00” is set in the degraded bit number field. This means that one intra-region address itself is expressed in the intra-region address field.

In a case where the corresponding address is degraded by 1 bit, for example, “01” is set in the degraded bit number field. This means that two (=21) merged intra-region addresses are expressed in the intra-region address field.

In a case where the corresponding address is degraded by 2 bits, for example, “10” is set in the degraded bit number field. This means that four (=22) merged intra-region addresses are expressed in the intra-region address field.

In a case where the corresponding address is degraded by 3 bits, for example, “11” is set in the degraded bit number field. This means that eight (=23) merged intra-region addresses are expressed in the intra-region address field.

With the above configuration, each entry of the access log 32 is capable of expressing a maximum of eight addresses. Therefore, even in a case where there is an upper limit to the maximum number N of entries of the access log 32, the access log 32 can include information that represents a maximum of (8×N) addresses. For example, in a case where the access log 32 includes the information that represents (8×N) addresses, the presented life of the memory system 3 becomes eight times that of the memory system 3C of the comparative example.

Here, an example in which the address merge unit 35 merges, in the access log 32, valid entries indicative of adjacent addresses will be described. The access log 32 illustrated in FIG. 6(a) includes four valid entries 321, 322, 323, and 324 each indicating a region number “0×14A3”.

An intra-region address “0100111011010110” of the entry 321 and an intra-region address “0100111011010111” of the entry 322 are different only in the least significant bit. An intra-region address “0100111011010101” of the entry 323 and an intra-region address “0100111011010100” of the entry 324 are different only in the least significant bit.

Therefore, the address merge unit 35 merges the entry 321 and the entry 322 by degrading the one least significant bit of the intra-region address. Similarly, the address merge unit 35 merges the entry 323 and the entry 324 by degrading the one least significant bit of the intra-region address.

The access log 32 illustrated in FIG. 6(b) includes an entry 321M in which the entry 321 and the entry 322 are merged, and an entry 323M in which the entry 323 and the entry 324 are merged.

In the entry 321M, the address merge unit 35 sets, in the degraded bit number field, “01” indicating that the one least significant bit of the address is degraded. Note that the least significant bit “x” of the address set in the intra-region address field is not used for comparison with a newly accessed address (that is, duplicate access detection), and indicates that any value may be used. The same applies to the entry 323M.

In addition, the address merge unit 35 sets “O” in the validity field of the entry 322. As a result, the entry 322 becomes an invalid entry. In other words, information indicated in the entry 322 is deleted from the access log 32 in accordance with being merged into the entry 321M. The same applies to the entry 324.

FIG. 7 illustrates a second example of the address merge in the access log 32. The access log 32 illustrated in FIG. 7(a) is the same as the access log 32 illustrated in FIG. 6(b). Here, a case where the address merge unit 35 further merges the entry 321M and the entry 323M will be described.

The intra-region address “010011101101011×” of the entry 321M and the intra-region address “010011101101010×” of the entry 323M are different only in a bit one level higher than the degraded least significant bit. Therefore, the address merge unit 35 merges the entry 321M and the entry 323M by degrading 2 bits from the least significant bit of the intra-region address.

The access log 32 illustrated in FIG. 7(b) includes an entry 321N in which the entry 323M and the entry 321M are merged. In the entry 321N, the address merge unit 35 sets, in the degraded bit number field, “10” indicating that 2 bits are degraded from the least significant bit. Two bits “xx” from the least significant bit of an address set in the intra-region address field are not used for comparison with a newly accessed address, and indicate that any value may be used.

In addition, the address merge unit 35 sets “0” in the validity field of the entry 323M. As a result, the entry 323M becomes an invalid entry. In other words, information indicated in the entry 323M is deleted from the access log 32 in accordance with being merged into the entry 321N.

Instead of the entry 321N obtained by merging the entry 323M into the entry 321M described above, the access log 32 may include an entry 323N obtained by merging the entry 321M into the entry 323M. In this case, information similar to that in the entry 321N is set in the entry 323N by the address merge unit 35. In addition, the address merge unit 35 invalidates the entry 321M by setting “0” in the validity field of the entry 321M.

With merge of entries that indicate adjacent addresses as illustrated in FIGS. 6 and 7, the access log 32 may represent a history of access to more addresses than the maximum number N of entries.

FIG. 8 illustrates an example of the eviction candidate list 37 selected by using the access log 32. Here, a case where the eviction candidate selection unit 36 selects eviction candidate regions 23 from the access log 32 illustrated in FIG. 8(a) will be explained. The access log 32 includes at least three valid entries 321N, 325, and 326.

The eviction candidate selection unit 36 selects, as the eviction candidate regions 23, one or more regions 23 from three regions 23 that are indicated in the valid entries 321N, 325, and 326, respectively, according to the specific rule. The three regions 23 are regions 23 with region numbers “0×14A3”, “0×COEO”, and “0×20A7”. In a case where the specific rule is a rule of preferentially selecting the LRU region 23, each entry of the access log 32 may further include a field of a timestamp that indicates a date and time of the most recent access to a corresponding address. Here, it is assumed that the eviction candidate selection unit 36 selects the region 23 with the region number “0×20A7” indicated in the entry 326 and then selects the region 23 with the region number “0×COEO” indicated in the entry 325.

In this case, the eviction candidate selection unit 36 generates the eviction candidate list 37 illustrated in FIG. 8(b). The eviction candidate list 37 includes one or more entries that correspond to one or more eviction candidate regions 23, respectively. Each of the one or more entries includes a priority field and a region number field.

The priority field indicates a priority as an eviction candidate of a corresponding region 23. In the priority field, for example, a smaller value is set as the priority is higher.

The region number field indicates a region number assigned to the corresponding region 23.

In the example of the eviction candidate list 37 illustrated in FIG. 8(b), the priority “1” and the region number “0×20A7” are set in an entry 371 that indicates the region 23 having the highest priority. The priority “2” and the region number “0×COEO” are set in an entry 372 that indicates the region 23 having the next highest priority.

The eviction candidate selection unit 36 sends the generated eviction candidate list 37 to the access log update unit 34. Accordingly, in a case where the access log 32 is full, the access log update unit 34 can identify an entry to be preferentially evicted from the access log 32, based on the region 23 (more specifically, the region number) indicated in the eviction candidate list 37.

With the configuration and operation of the wear management circuit 15 described above, the access log 32 can include information indicative of addresses more than the maximum number N of entries even in a case where the maximum number N of entries of the access log 32 is limited. As a result, the wear management circuit 15 can improve the effect of reducing the pessimism for the degree of wear-out per region by using the access log 32, and can maintain the processing performance of the memory system 3 (for example, processing performance of G accesses/second).

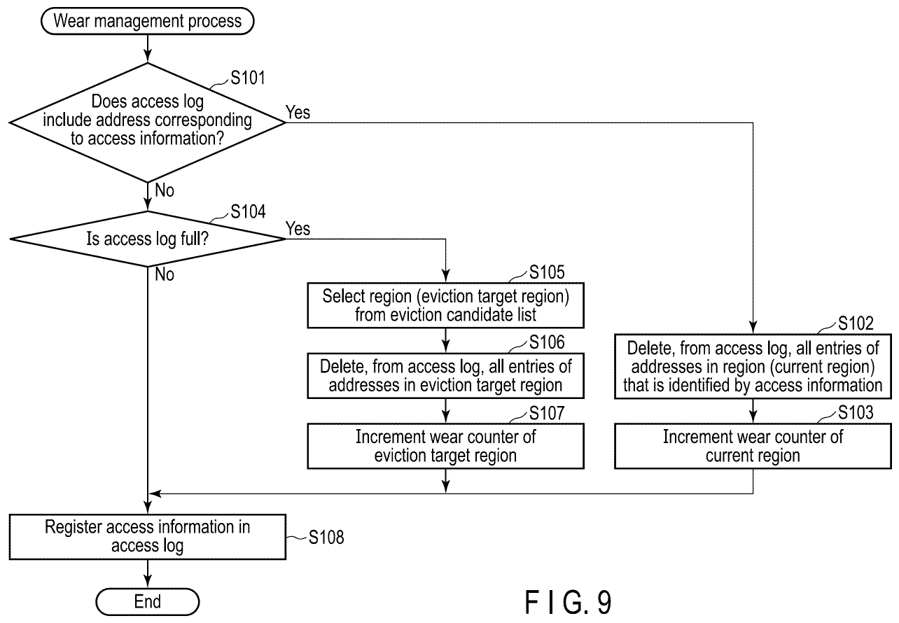

With reference to FIGS. 9 to 11, processes executed in the memory system 3 will be described.

FIG. 9 is a flowchart illustrating an example of a procedure of a wear management process executed by the wear management circuit 15. The wear management process is a process for managing the degree of wear-out of each region 23 on the basis of the access information 7. In the wear management process, a corresponding wear counter 33 is incremented (1) in a case where duplicate access to an address included in the access log 32 has been detected and (2) in a case where all valid entries corresponding to an eviction target region 23 have been deleted from the access log 32 (that is, in a case where the valid entries have become invalid entries). The wear management circuit 15 executes the wear management process in response to an input of the access information 7.

First, the wear management circuit 15 determines whether or not the access log 32 includes an address corresponding to the input access information 7 (S101). The address corresponding to the access information 7 is an address identified by a combination of a region number and an intra-region address that are included in the access information 7. Specifically, the wear management circuit 15 determines, based on the combination of the region number and the intra-region address in the access information 7, whether or not the access log 32 includes a valid entry corresponding the combination.

In a case where the access log 32 includes the address corresponding to the access information 7 (Yes in S101), the wear management circuit 15 deletes, from the access log 32, all entries of addresses that are included in the current region 23 (S102). The current region 23 is a region 23 identified by the access information 7 (that is, a region 23 identified by the region number in the access information 7). Specifically, for example, the wear management circuit 15 sets the invalid bit in all valid entries in the access log 32 that each include the region number of the current region 23 (that is, sets “0” in the validity fields), thereby changing these valid entries to invalid entries. Then, the wear management circuit 15 increments the wear counter 33 of the current region 23 (S103), and the process proceeds to S108.

In a case where the access log 32 does not include the address corresponding to the access information 7 (No in S101), the wear management circuit 15 determines whether or not the access log 32 is full (S104). That is, the wear management circuit 15 determines whether or not the number of valid entries included in the access log 32 has reached the maximum number N of entries that can be stored in the access log 32.

In a case where the access log 32 is full (Yes in S104), the wear management circuit 15 selects, as an eviction target region 23, one region 23 from the eviction candidate list 37 (S105). Specifically, the wear management circuit 15 selects, as the eviction target region 23, one region 23 having the highest priority from the eviction candidate list 37. The wear management circuit 15 deletes, from the access log 32, all entries that each indicate any of addresses included in the eviction target region 23 (S106). Specifically, for example, the wear management circuit 15 sets the invalid bit in all valid entries in the access log 32 that each include the region number of the eviction target region 23, thereby changing these valid entries to invalid entries. Then, the wear management circuit 15 increments the wear counter 33 of the eviction target region 23 (S107), and the process proceeds to S108.

In a case where the access log 32 is not full (No in S104), that is, in a case where the access log 32 includes a free entry, the process proceeds to S108.

Next, the wear management circuit 15 registers the access information 7 in the access log 32 (S108). Specifically, the wear management circuit 15 adds, to the access log 32, for example, an entry in which the valid bit and the region number and the intra-region address, which are included in the access information 7, are set. Alternatively, the wear management circuit 15 may set the valid bit and the region number and the intra-region address, which are included in the access information 7, in an invalid entry in the access log 32. Then, the wear management circuit 15 ends the wear management process.

Through the wear management process described above, the wear management circuit 15 manages the degree of wear-out per region. The wear management circuit 15 detects the presence or absence of the possibility of duplicate access to the address corresponding to the access information 7, based on the input access information 7 and the stored access log 32, thereby eliminating the pessimism for the degree of wear-out per region. Specifically, in a case where the access log 32 includes the address corresponding to the access information 7, the wear management circuit 15 increments the wear counter 33 of the current region 23. In addition, in a case where the access log 32 does not include the address corresponding to the access information 7 and the access log 32 is full, the wear management circuit 15 deletes, from the access log 32, all the entries that each indicate any of the addresses included in the eviction target region 23, and increments the wear counter 33 of the eviction target region 23.

Therefore, the wear management circuit 15 can eliminate the pessimism for the degree of wear-out per region by using the access log 32.

In the wear management process of FIG. 9 described above, the wear management circuit 15 increments the wear counter 33 of the eviction target region 23. As another example of the procedure of the wear management process, the wear management circuit 15 may increment the wear counter 33 of a region 23 in a case of newly adding (registering) an entry corresponding to the region 23 to the access log 32 that does not include any valid entry corresponding to the region 23.

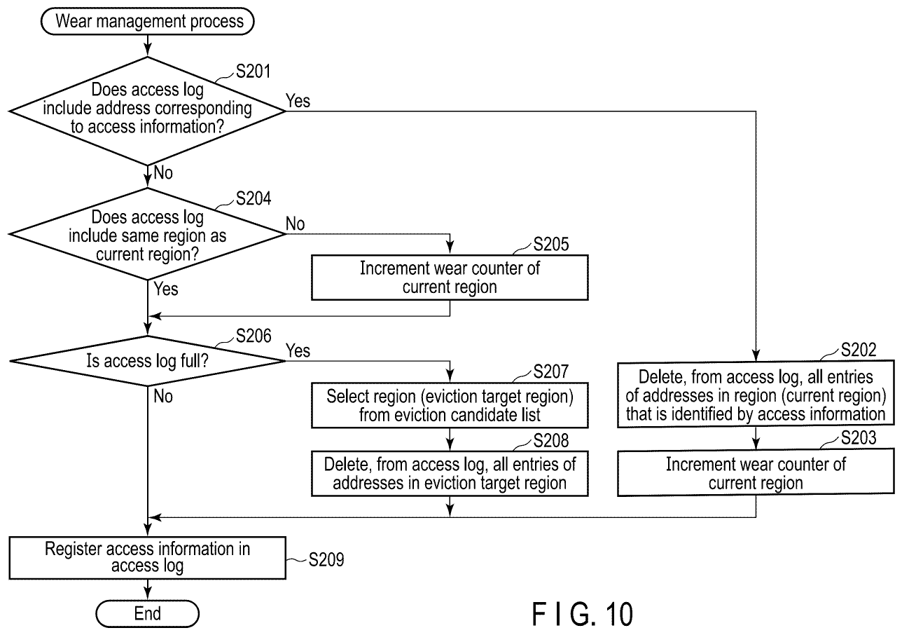

FIG. 10 is a flowchart illustrating another example of the procedure of the wear management process executed by the wear management circuit 15. In this wear management process, a corresponding wear counter 33 is incremented (1) in a case where duplicate access to an address included in the access log 32 has been detected, and (2) in a case where a valid entry corresponding to a region 23 is newly added to the access log 32 that does not include any valid entry corresponding to the region 23. Some processes in the flowchart of FIG. 10 are the same as some processes in the flowchart of FIG. 9, respectively.

First, the wear management circuit 15 determines whether or not the access log 32 includes the address corresponding to the input access information 7 (S201). The process of S201 is similar to the process of S101 of the wear management process described above with reference to FIG. 9.

Process of S202, S203, and S209 in a case where the access log 32 includes the address corresponding to the access information 7 (Yes in S201) are similar to the process of S102, S103, and S108 in FIG. 9 described above.

In a case where the access log 32 does not include the address corresponding to the access information 7 (No in S201), the wear management circuit 15 determines whether or not the access log 32 includes an entry (more particularly, a valid entry) that indicates the same region 23 as a region 23 (current region 23) indicated in the access information 7 (S204).

In a case where the access log 32 includes the entry that indicates the same region 23 as the current region 23 (Yes in S204), the process proceeds to S206.

In a case where the access log 32 does not include any entry that indicates the same region 23 as the current region 23 (No in S204), the wear management circuit 15 increments the wear counter 33 of the current region 23 (S205), and the process proceeds to S206.

Next, the wear management circuit 15 determines whether or not the access log 32 is full (S206). The process of S206 is similar to the process of S104 of the wear management process described above with reference to FIG. 9.

Process of S207, S208, and S209 in a case where the access log 32 is full (Yes in S206) are similar to the process of S105, S106, and S108 of the wear management process described above with reference to FIG. 9.

The process of S209 in a case where the access log 32 is not full (includes a free entry) (No in S206) is similar to the process of S108 of the wear management process described above with reference to FIG. 9.

Through the wear management process described above, the wear management circuit 15 manages the degree of wear-out per region. The wear management circuit 15 detects the presence or absence of the possibility of duplicate access to the address corresponding to the access information 7, based on the input access information 7 and the stored access log 32, thereby eliminating the pessimism for the degree of wear-out per region. Specifically, in a case where the access log 32 includes the address corresponding to the access information 7, the wear management circuit 15 increments the wear counter 33 of the current region 23. In addition, in a case where the access log 32 does not include any valid entry corresponding to the current region 23 indicated in the access information 7, the wear management circuit 15 increments the wear counter 33 of the current region 23. Therefore, the wear management circuit 15 can eliminate the pessimism for the degree of wear-out per region by using the access log 32.

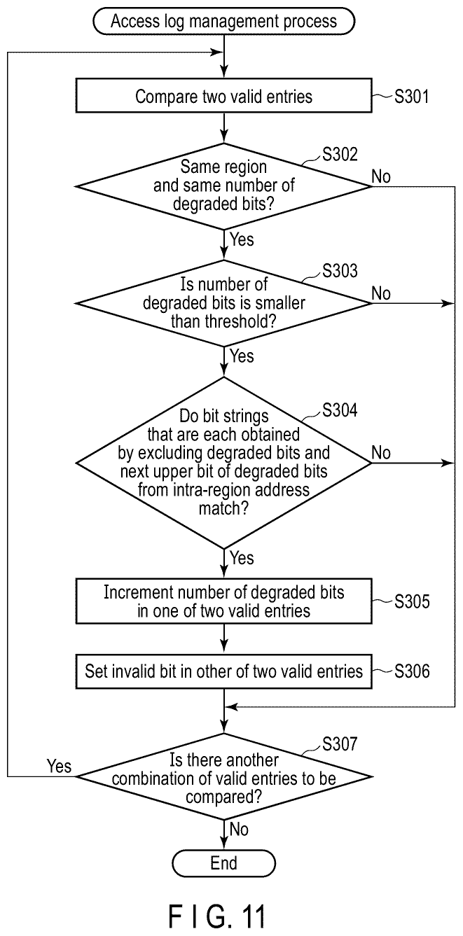

FIG. 11 is a flowchart illustrating an example of a procedure of an access log management process executed by the wear management circuit 15. The access log management process is a process for merging a plurality of entries included in the access log 32. The wear management circuit 15 executes the access log management process asynchronously with the wear management process. Specifically, the wear management circuit 15 executes the access log management process, for example, at regular time intervals or in a case where the F/F circuits that implements the access log 32 are not in the busy state.

First, the wear management circuit 15 compares two valid entries in the access log 32 (S301). For example, the wear management circuit 15 performs, for a combination of two valid entries, bit string comparison between the entries, in order from the head of the access log 32. The wear management circuit 15 determines whether or not the two valid entries are entries of the same region and the same number of degraded bits (S302).

In a case where the two valid entries are not entries of the same region and the same number of degraded bits (No in S302), the process proceeds to S307.

In a case where the two valid entries are entries of the same region and the same number of degraded bits (Yes in S302), the wear management circuit 15 determines whether or not the number of degraded bits is smaller than a threshold (S303).

In a case where the number of degraded bits is equal to or larger than the threshold (No in S303), the process proceeds to S307.

In a case where the number of degraded bits is smaller than the threshold (Yes in S303), the wear management circuit 15 determines whether or not bit strings that are obtained by excluding zero or more degraded bits and a next upper bit of the degraded bits from the respective intra-region addresses in the two valid entries match each other (S304).

In a case where the bit strings obtained by excluding the degraded bits and the next upper bit of the degraded bits from the respective intra-region addresses are different from each other (No in S304), the process proceeds to S307.

In a case where the bit strings obtained by excluding the degraded bits and the next upper bit of the degraded bits from the respective intra-region addresses match each other (Yes in S304), the wear management circuit 15 increments the number of degraded bits of one of the entries (hereinafter, referred to as an entry A) (S305). In addition, the wear management circuit 15 sets the invalid bit in the other of the entries (hereinafter, referred to as an entry B) (S306). Therefore, the entry A becomes an entry in which the number of degraded bits is increased by one, and the entry B becomes an invalid entry. That is, the wear management circuit 15 merges the entry A and the entry B into the single entry A in S305 and S306. Then, the process proceeds to S307.

Next, the wear management circuit 15 determines whether or not the access log 32 includes another combination of valid entries to be compared (S307). That is, the wear management circuit 15 determines whether or not the access log 32 includes a combination of valid entries that have not been compared yet.

In a case where the access log 32 includes another combination of valid entries to be compared (Yes in S307), the process returns to S301.

In a case where the access log 32 does not include any combination of valid entries to be compared, that is, in a case where the comparison has been completed for all combinations of valid entries (No in S307), the wear management circuit 15 ends the access log management process.

Through the access log management process described above, the wear management circuit 15 can merge two entries indicative of adjacent addresses based on the numbers of degraded bits, into one entry.

As a result, information regarding more addresses can be represented with a limited number of entries that can be stored in the access log 32.

As described above, in the memory system 3 of the first embodiment, it is possible to maintain the processing performance while eliminating the pessimism for the degree of wear-out per region by using the access log 32.

### Second Embodiment

The memory system 3 according to the first embodiment determines whether or not there is a possibility of duplicate access to a current address on the basis of the access log 32 that indicates a history of past addresses.

On the other hand, a memory system 3 according to a second embodiment determines whether or not there is a possibility of duplicate access to a current address by using a bloom filter (BF). In the determination, a BF bit pattern table that indicates a BF bit pattern for each region is used. The BF bit pattern corresponding to a region 23 is calculated by using a history of past access to addresses included in the region 23. In a case where access to an address in the region 23 is performed, the memory system 3 compares a BF bit pattern generated by using the address with a BF bit pattern corresponding to the region 23 in the BF bit pattern table, thereby determining whether or not there is a possibility of duplicate access. Therefore, in the memory system 3 of the second embodiment, since two BF bit patterns are compared, for example, it is not necessary to compare one BF bit pattern with each of a plurality of BF bit patterns in the BF bit pattern table in parallel.

A configuration of the memory system 3 of the second embodiment is similar to that of the memory system 3 of the first embodiment. The memory system 3 of the second embodiment is different from the memory system 3 of the first embodiment in that a process of determining whether or not there is a possibility of duplicate access is executed by using the BF bit pattern table indicative of the BF bit pattern for each region instead of the access log 32. Hereinafter, the difference from the first embodiment will be mainly described.

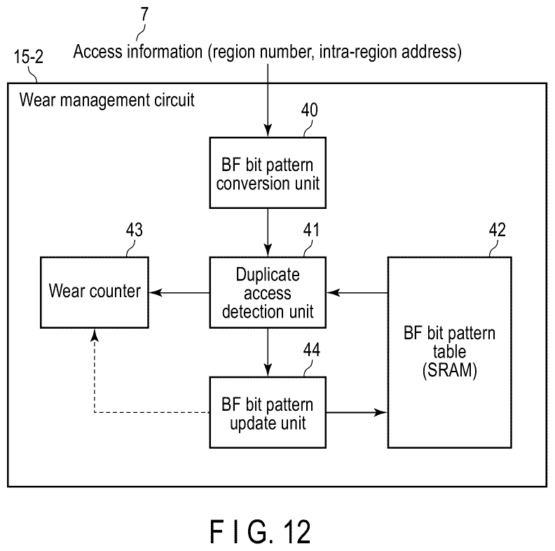

FIG. 12 is a block diagram illustrating a configuration example of a wear management circuit 15-2 of the memory system 3 according to the second embodiment. The configuration of the memory system 3 according to the second embodiment corresponds to, for example, a configuration in which the wear management circuit 15 of the memory system 3 according to the first embodiment described above with reference to FIG. 1 is replaced with the wear management circuit 15-2.

The wear management circuit 15-2 is a circuit for managing a degree of wear-out of a nonvolatile memory 4. Specifically, the wear management circuit 15-2 manages the degree of wear-out of the nonvolatile memory 4 for each region by using access information 7 received from an access processing module 141 and a BF bit pattern that indicates a history of past access to addresses included in each region 23.

The access information 7 is input to the wear management circuit 15-2 in response to access to the nonvolatile memory 4. The access information 7 includes, for example, a region number and an intra-region address. The wear management circuit 15-2 includes, for example, a BF bit pattern conversion unit 40, a duplicate access detection unit 41, a BF bit pattern table 42, a wear counter 43 for each region, and a BF bit pattern update unit 44.

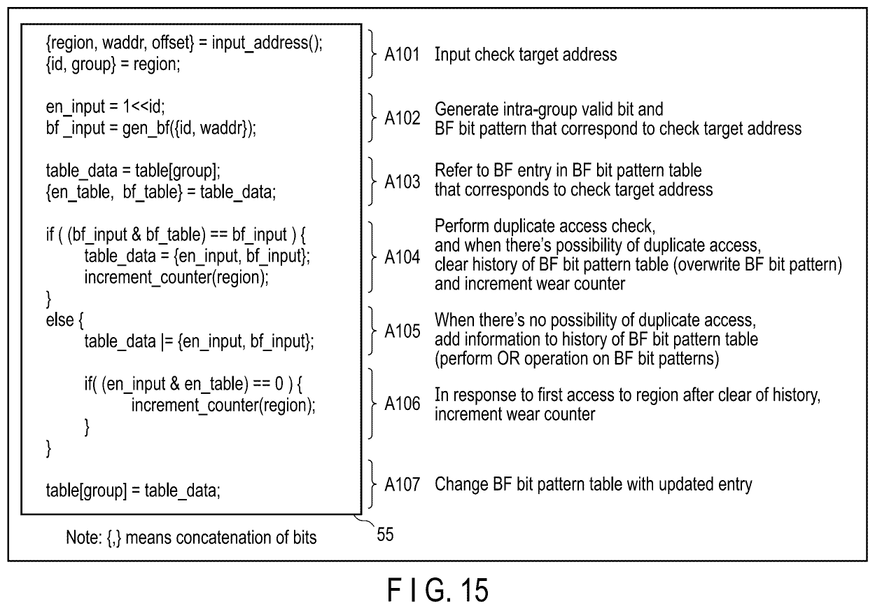

The BF bit pattern conversion unit 40 converts an address (current address) indicated in the access information 7 into a BF bit pattern (hereinafter, also referred to as a BF bit pattern A). For the conversion, for example, one or more hash functions are used. The BF bit pattern conversion unit 40 sends the BF bit pattern A to the duplicate access detection unit 41. A specific method of converting the current address into the BF bit pattern A is described below with reference to FIGS. 15 to 18.

The duplicate access detection unit 41 performs a duplicate access check by using the BF. That is, the duplicate access detection unit 41 performs the duplicate access check by using the BF bit pattern A and the BF bit pattern table 42.

Specifically, the duplicate access detection unit 41 identifies an entry in the BF bit pattern table 42 that corresponds to a region 23 (current region 23) based on the access information 7. An entry included in the BF bit pattern table 42 is also referred to as a BF entry. The identified BF entry is also referred to as a target BF entry. The duplicate access detection unit 41 compares the BF bit pattern (hereinafter, also referred to as a BF bit pattern B) set in the target BF entry with the BF bit pattern A, thereby determining whether or not there is a possibility that current access (that is, access to the current address) is duplicate access.

On the basis of the determination result of the duplicate access check (that is, the determination result as to whether or not there is a possibility that the current access is duplicate access), the duplicate access detection unit 41 determines whether or not to increase the degree of wear-out of the current region 23. Specifically, in a case where there is a possibility that the current access is duplicate access, the duplicate access detection unit 41 sends an increment instruction for the degree of wear-out of the current region 23 to the wear counter 43. In a case where there is no possibility that the current access is duplicate access, the duplicate access detection unit 41 does not send any increment instruction for the degree of wear-out of the current region 23 to the wear counter 43.

In addition, the duplicate access detection unit 41 sends the determination result of the duplicate access check, the access information 7, the BF bit pattern A, and the target BF entry to the BF bit pattern update unit 44.

The BF bit pattern table 42 is data representing a history of access to each of Q regions 23, which are managed by the memory system 3, with a BF bit pattern. The BF bit pattern table 42 includes, for example, Q entries that correspond to the Q regions 23, respectively. That is, Q BF bit patterns are managed in the BF bit pattern table 42.

Alternatively, the BF bit pattern table 42 may include a plurality of entries that correspond to a plurality of region groups, respectively. The region group is a group to which a plurality of regions 23 belong. For example, R regions 23 among the Q regions 23 belong to each region group. R is an integer of Q or less. In this case, the BF bit pattern table 42 includes (Q/R) entries that correspond to (Q/R) region groups, respectively. That is, (Q/R) BF bit patterns are managed in the BF bit pattern table 42. For example, R regions 23 scattered in an address space 21 may belong to each region group instead of contiguous R regions 23 in the address space 21. In other words, the contiguous regions 23 in the address space 21 may belong to different region groups, for example.

The BF bit pattern table 42 includes the entries that correspond to all the regions 23 (or all the region groups), respectively, which are managed by the memory system 3. Therefore, it is not necessary to execute a process for evicting an entry of any region 23 (or region group) from the BF bit pattern table 42.

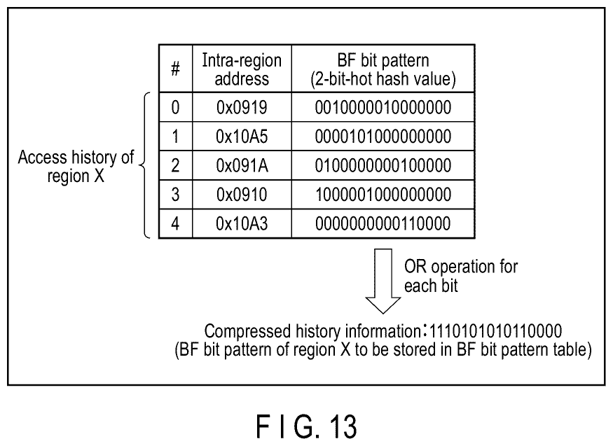

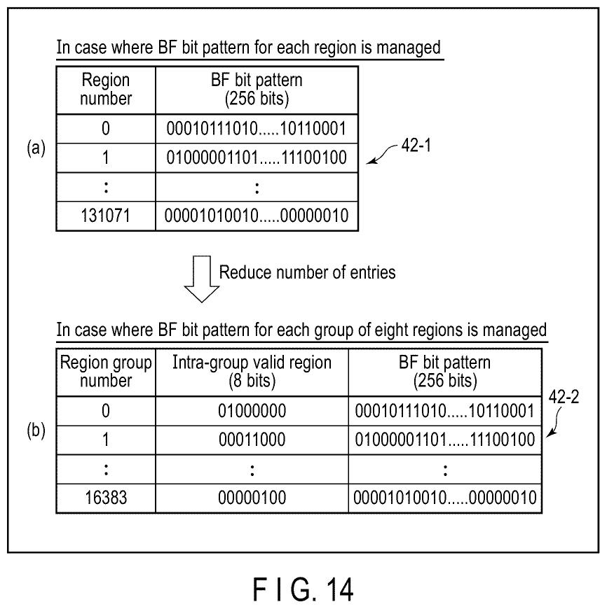

As described above, the duplicate access check is performed by comparing the BF bit pattern A with the BF bit pattern B in the target BF entry. Therefore, in the memory system 3 of the second embodiment, it is not necessary to compare the BF bit pattern A with each of the plurality of BF bit patterns in the BF bit pattern table 42 in parallel. Therefore, the BF bit pattern table 42 is implemented by, for example, an SRAM instead of F/F circuits. A specific configuration example of the BF bit pattern table 42 is described below with reference to FIGS. 13 and 14.

The wear counter 43 is similar to the wear counter 33 of the wear management circuit 15 of the first embodiment.

The BF bit pattern update unit 44 updates the target BF entry in the BF bit pattern table 42 by using the determination result of the duplicate access check, the access information 7, the BF bit pattern A, and the target BF entry that have been received from the duplicate access detection unit 41.

In a case where the determination result of the duplicate access check indicates that there is a possibility that the current access is duplicate access, the BF bit pattern update unit 44 clears (for example, performs all-0 clear on) the target BF entry in the BF bit pattern table 42. That is, the BF bit pattern update unit 44 sets a bit string in which all bits are 0 as the BF bit pattern in the target BF entry. Then, the BF bit pattern update unit 44 sets the BF bit pattern A in the target BF entry.

In a case where the result of the duplicate access check indicates that there is no possibility that the current access is duplicate access, the BF bit pattern update unit 44 sets a logical OR of the BF bit pattern A and the BF bit pattern B, in the target BF entry in the BF bit pattern table 42.

In other words, in a case where the BF bit pattern for each region is managed in the BF bit pattern table 42, the BF bit pattern update unit 44 converts, into a BF bit pattern, one or more addresses that indicate one or more accessed access units, respectively, among P access units 22 in the current region 23. Furthermore, in a case where the BF bit pattern for each region group is managed in the BF bit pattern table 42 and the R regions 23 belong to each region group, the BF bit pattern update unit 44 converts, into a BF bit pattern, one or more addresses that indicate one or more accessed access units, respectively, among (RxP) access units 22 in the region group to which the current region 23 belongs. The one or more addresses are non-matching addresses. The BF bit pattern generated (calculated) by the BF bit pattern update unit 44 is a logical OR of one or more BF bit patterns into which the one or more addresses are converted, respectively. The BF bit pattern update unit 44 sets this BF bit pattern in the target BF entry.

Note that in a case where the result of the duplicate access check indicates that there is no possibility that the current access is duplicate access and the current access is the first access to the current region 23 after the target BF entry is cleared, the BF bit pattern update unit 44 may send an increment instruction for the degree of wear-out of the current region 23 to the wear counter 43.

A specific method of performing the duplicate access check, incrementing the wear counter 43, and updating the target BF entry is described below with reference to FIG. 15 to FIG. 18.

FIG. 13 illustrates an example of a BF bit pattern generated by the BF bit pattern conversion unit 40 and the BF bit pattern update unit 44. Here, a case where a BF bit pattern corresponding to a region X is calculated based on five accesses from the 0-th to fourth accesses to the region X will be explained. It is assumed that five intra-region addresses that are targets of the five accesses do not match.

The BF bit pattern conversion unit 40 generates a BF bit pattern by performing conversion using L hash functions on an intra-region address to be accessed. The conversion using the L hash functions is conversion for generating a BF bit pattern of L-bit-hot. In the BF bit pattern of L-bit-hot, L bits of a bit string of the BF bit pattern are 1, and the other bits of the bit string are 0. L is, for example, an integer of one or more. For example, L that minimizes a probability of occurrence of false positive (false positive occurrence probability) is determined based on the number P of addresses included in one region 23 and the bit length of the BF bit pattern. Here, it is assumed that the conversion using the L hash functions is conversion using two hash functions. That is, the BF bit pattern conversion unit 40 generates a BF bit pattern of 2-bit-hot. The generated BF bit pattern is transmitted from the BF bit pattern conversion unit 40 to the BF bit pattern update unit 44 via the duplicate access detection unit 41.

Every time a BF bit pattern converted from an intra-region address to be newly accessed is generated for the region X, the BF bit pattern update unit 44 performs a logical OR (OR) operation for each bit on the generated BF bit pattern and the BF bit pattern of the region X in the BF bit pattern table 42. The BF bit pattern update unit 44 sets the BF bit pattern obtained by the OR operation as a new BF bit pattern of the region X in the BF bit pattern table 42.

In the example illustrated in FIG. 13, the BF bit pattern conversion unit 40 converts the 0-th accessed intra-region address “0×0919” into a BF bit pattern “0010000010000000”. The BF bit pattern conversion unit 40 converts the first accessed intra-region address “0×10A5” into a BF bit pattern “0000101000000000”. The BF bit pattern conversion unit 40 similarly converts each of the second to fourth accessed intra-region addresses into a BF bit pattern.

The BF bit pattern update unit 44 performs the OR operation on the five BF bit patterns respectively converted from the 0-th to fourth intra-region addresses, thereby generating a BF bit pattern “1110101010110000”. The BF bit pattern update unit 44 sets the generated BF bit pattern “1110101010110000” as the BF bit pattern of the region X in the BF bit pattern table 42.

The BF bit pattern “1110101010110000” generated by the BF bit pattern update unit 44 is information obtained by compressing a history of access to the region X that includes the 0-th to fourth intra-region addresses. Therefore, in the BF bit pattern table 42, a BF bit pattern obtained by compressing a history of access to one or more intra-region addresses is stored for each region. That is, the BF bit pattern for each region included in the BF bit pattern table 42 has a constant data amount (bit length) that does not depend on the number of intra-region addresses that were used for generating the BF bit pattern. Then, in a case where an intra-region address included in a region 23 is accessed, a BF bit pattern converted from the intra-region address is compared with the BF bit pattern that corresponds to the region 23 in the BF bit pattern table 42, and thus, the presence or absence of the possibility of duplicate access is detected.

Therefore, in the memory system 3 of the second embodiment, in the case of detecting the presence or absence of the possibility of duplicate access to an address, it is not necessary to compare a BF bit pattern converted from the address with each of all the BF bit patterns in the BF bit pattern table 42 in parallel. As a result, even in a case where the number of BF entries included in the BF bit pattern table 42 is large, processing performance (for example, processing performance of G accesses/second) of the memory system 3 can be maintained. In addition, in the memory system 3, for example, in a case where the bit length of a BF bit pattern is 256 bits, an improvement rate of the presented life is about 40 (about 4000%) at the maximum regardless of access locality as compared with a case where the BF bit pattern table 42 is not used. Furthermore, in the memory system 3, even in a case where access is distributed across the regions 23, an effect of reducing the pessimism for the degree of wear-out is hardly deteriorated.

As described above, the BF bit pattern may be managed for each region or may be managed for each region group.

FIG. 14 illustrates (a) a configuration example of a BF bit pattern table 42-1 that includes the BF bit pattern for each region and (b) a configuration example of a BF bit pattern table 42-2 that includes the BF bit pattern for each region group, which are managed in the wear management circuit 15-2.

The BF bit pattern table 42-1 illustrated in FIG. 14(a) includes Q BF entries that correspond to the Q regions 23, respectively. That is, the number of BF entries included in the BF bit pattern table 42-1 corresponds to the number Q of the regions 23 managed in the memory system 3. Here, a case where the number Q of the regions 23 is 131072 is illustrated. Each of the Q BF entries includes, for example, a region number field and a BF bit pattern field.

The region number field indicates a region number assigned to a corresponding region 23.

The BF bit pattern field indicates a BF bit pattern generated based on a history of access to addresses included in the corresponding region 23. The bit length of the BF bit pattern field is, for example, 256 bits. In an initial state in which no address in the corresponding region 23 is accessed, a bit string in which all bits are 0 is set in the BF bit pattern field. In response to access to any address (that is, any intra-region address) in the corresponding region 23, the presence or absence of the possibility of duplicate access is detected by using a BF bit pattern (BF bit pattern A) converted from the address and the BF bit pattern (BF bit pattern B) set in the BF bit pattern field. In a case where the possibility of duplicate access is not detected, the logical OR of the BF bit pattern A and the BF bit pattern B is newly set in the BF bit pattern field. In a case where possibility of the duplicate access has been detected, the BF bit pattern field is cleared. That is, the bit string in which all the bits are 0 is set in the BF bit pattern field.

Note that, for example, after the BF bit pattern field is cleared, the wear counter 43 of the corresponding region 23 may be incremented in response to the first access to the region 23.

In the example illustrated in FIG. 14(a), a BF bit pattern “00010111010 . . . 10110001” is set for the region 23 with a region number “0”. In addition, a BF bit pattern “00001010010 . . . 00000010” is set for the region 23 with a region number “131071”.

The BF bit pattern table 42-2 illustrated in FIG. 14(b) includes (Q/R) BF entries that correspond to the (Q/R) region groups, respectively. The number of BF entries included in the BF bit pattern table 42-2 corresponds to, for example, the number of the region groups managed in the memory system 3. Here, a case where eight regions 23 belong to one region group (that is, R=8) will be explained. For example, in a case where the number Q of the regions is 131072, the BF bit pattern table 42-2 includes 16384 (=131072/8) BF entries. Each of the (Q/R) BF entries includes, for example, a region group number field, an intra-group valid region field, and a BF bit pattern field.

The region group number field indicates information by which a corresponding region group is uniquely identifiable. The information by which a region group is uniquely identifiable is a number (region group number) assigned to the region group.

The intra-group valid region field indicates whether or not there is a history of access to each of the R regions 23 that belong to the corresponding region group. The intra-group valid region field has a bit length corresponding to the number R of regions 23 that belong to the region group (here, 8 bits). R bits of a bit string set in the intra-group valid region field correspond to the R regions 23 belonging to the region group, respectively. That is, each of the R bits indicates whether or not there is a history of access to the corresponding region 23. In the intra-group valid region field, a bit corresponding to a region 23 is also referred to as an intra-group valid bit of the region 23. In a case where there is no history of access to a region 23, an invalid bit is set as the intra-group valid bit of the region 23. The invalid bit is, for example, “0”. In a case where there is a history of access to a region 23, a valid bit is set as the intra-group valid bit of the region 23. The valid bit is, for example, “1”.

In an initial state in which no region 23, which belongs to the region group, has not been accessed, for example, a bit string in which all bits are 0 is set in the intra-group valid region field. In response to the first access to a region 23 (more specifically, any address in the region 23) that belongs to the corresponding region group, a value set as the intra-group valid bit of the region 23 is changed from “0” to “1”, for example.

The BF bit pattern field indicates a BF bit pattern generated based on a history of access to addresses in each region 23 that belongs to the corresponding region group. The bit length of the BF bit pattern field is, for example, 256 bits. The bit length of the BF bit pattern field in a case where the BF bit pattern for each region group is managed may be larger than that in a case where the BF bit pattern for each region is managed. In this case, the false positive occurrence probability in the duplicate access check can be reduced.

As described above, in the initial state, the bit string in which all the bits are 0 is set in the BF bit pattern field. In response to access to any address in each region 23 that belongs to the region group, the presence or absence of the possibility of duplicate access is detected by using a BF bit pattern (hereinafter, referred to as a BF bit pattern C) converted from the address and a BF bit pattern (hereinafter, referred to as a BF bit pattern D) set in the BF bit pattern field. In a case where the possibility of duplicate access is not detected, a logical OR (OR) of the BF bit pattern C and the BF bit pattern D is newly set in the BF bit pattern field.

That is, the logical OR of the BF bit patterns respectively corresponding to all the regions that belong to the region group is set in the BF bit pattern field. In a case where the possibility of duplicate access has been detected, the BF bit pattern field is cleared (for example, all-0 clear), and the intra-group valid region field is also cleared. That is, the bit string in which all the bits are 0 is set in both the BF bit pattern field and the intra-group valid region field.

Note that, for example, after the BF bit pattern field and the intra-group valid region field are cleared, in response to the first access to a region 23 that belongs to the corresponding region group (that is, in response to the intra-group valid bit of the region 23 changing from “0” to “1”), the wear counter 43 of the region 23 may be incremented.

The number of entries in the BF bit pattern table 42-2 in which the BF bit pattern for each region group is managed can be reduced as compared with the BF bit pattern table 42-1 in which the BF bit pattern for each region is managed. Therefore, a table capacity of the BF bit pattern table 42-2 can be reduced as compared with the BF bit pattern table 42-1.

In a case where the number of addresses to be converted (compressed) into one BF bit pattern increases, there is a possibility that false detection (occurrence of false positive) of duplicate access increases in the duplicate access check. In response to the false detection of duplicate access, the degree of wear-out of the corresponding region 23 is incremented. However, the increment of the degree of wear-out in response to the false detection causes no problem in the application of managing the worst degree of wear-out of each region 23.

Next, an operation of the wear management circuit 15-2 that counts the degree of wear-out by using BF bit patterns will be described with reference to a pseudo code illustrated in FIGS. 15 to 17.

FIG. 15 illustrates an example of the pseudo code that corresponds to the operation of the wear management circuit 15-2. Here, a case where the BF bit pattern is managed for each region group will be explained. In the pseudo code 55, “{,}” means a concatenation of a plurality of bit strings. For example, “{A, B}” is a bit string in which a bit string A and a bit string B are concatenated.

First, an address to be checked (checking target address) for duplicate access is input to the wear management circuit 15-2 (A101). The checking target address corresponds to the access information 7.

Specifically, a bit string in which region, waddr, and offset are concatenated is input as the checking target address. region is a bit string indicative of a region number. waddr is a bit string indicative of a word address (intra-region address). offset is a bit string indicative of an intra-word offset.

Then, the BF bit pattern conversion unit 40 extracts, from region, a bit string in which id and group are concatenated. id is a bit string indicative of an intra-group region ID. For example, in a case where eight regions 23 belong to one region group, id is any value from 0 to 7. group is a bit string indicative of a region group number.

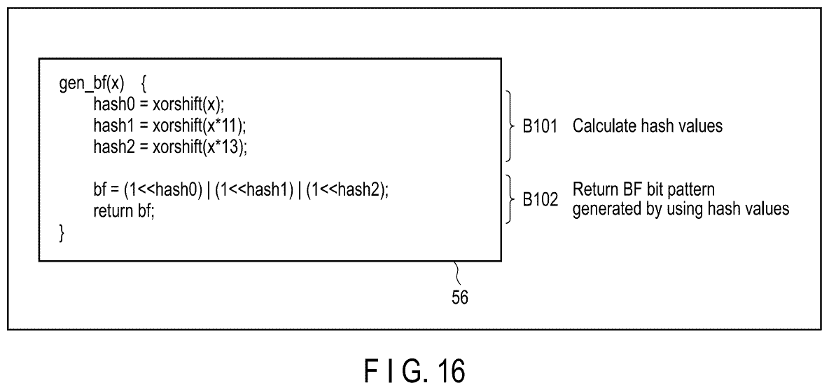

Next, the wear management circuit 15-2 generates an in-group valid bit en input and a BF bit pattern bf input that correspond to the checking target address (A102). Specifically, the wear management circuit 15-2 performs an operation of shifting 1 to the left by the number of bits that corresponds to id (i.e., that is indicated by id), thereby generating the in-group valid bit en input. Note that “<<” is a left shift operator. The wear management circuit 15-2 generates the BF bit pattern bf input by using a gen bf function with an argument that is a bit string in which id and waddr are concatenated. The gen bf function is a function that generates the BF bit pattern based on the argument. A specific example of the gen bf function is described below with reference to FIG. 16.

The wear management circuit 15-2 refers to a BF entry in the BF bit pattern table 42 that corresponds to the checking target address (A103). Specifically, the wear management circuit 15-2 acquires, as table data, a BF entry table [group] in the BF bit pattern table 42 that corresponds to the region group number (group). Then, the wear management circuit 15-2 extracts, from table data, a bit string in which en table and bf table are concatenated. en table is a bit string that is set in the BF bit pattern table 42 and indicates intra-group valid regions corresponding to the region group number (group). bf table is a BF bit pattern that is set in the BF bit pattern table 42 and corresponds to the region group number (group).

The wear management circuit 15-2 performs the duplicate access check by using the BF bit pattern bf input and the BF bit pattern bf table, and in a case where there is a possibility of duplicate access, clears the BF entry of the BF bit pattern table 42 corresponding to the region group number (group) and increments the corresponding wear counter 43 (A104). Specifically, in a case where a result of an AND operation (logical AND) of the BF bit pattern bf input and the BF bit pattern bf table matches the BF bit pattern bf input, the wear management circuit 15-2 sets, as table data, a bit string in which the in-group valid bit en input and the BF bit pattern bf input are concatenated. That is, the wear management circuit 15-2 clears table data that indicates the history of the intra-group valid region and the BF bit pattern that correspond to the region group number (group), and overwrites table data with the bit string in which the intra-group valid bit en input and the BF bit pattern bf input are concatenated. Then, the wear management circuit 15-2 increments the wear counter 43 corresponding to the region number (region).

In a case where there is no possibility of duplicate access, the wear management circuit 15-2 adds information regarding the in-group valid bit en input and the BF bit pattern bf input corresponding to the checking target address to table data (A105). Specifically, the wear management circuit 15-2 sets, as table data, a result of an OR operation (logical OR) of table data and a bit string in which the intra-group valid bit en input and the BF bit pattern bf input are concatenated.

Then, in response to the first access to the region 23 of the region number (region) after clearing the BF entry of the BF bit pattern table 42 that corresponds to the region group number (group), the wear management circuit 15-2 increments the wear counter 43 of the region 23 (A106). Specifically, in a case where a logical AND of the intra-group valid bit en input corresponding to the checking target address and the intra-group valid region en table corresponding to the region group number group is 0, the wear management circuit 15-2 increments the wear counter 43 corresponding to the region 23 of the region number (region).

Finally, the wear management circuit 15-2 reflects (sets) the updated table data in the BF entry table [group] in the BF bit pattern table 42 that corresponds to the region group number (group) (A107).

With the pseudo code 55 described above, the wear management circuit 15-2 can manage the degree of wear-out per region by using the BF bit pattern table 42.

FIG. 16 illustrates an example of a pseudo code of the gen bf function that is included in the pseudo code 55 of FIG. 15 and generates a BF bit pattern. The gen bf function 56 generates a BF bit pattern based on an argument x. The argument x is, for example, a bit string in which an intra-group region ID and a word address are concatenated. The gen bf function 56 is implemented by freely selected hash functions. Here, a case where three hash functions are used in the gen bf function 56 will be explained. The number of hash functions used in the gen bf function 56 is determined by numerical calculation so that the false positive occurrence probability is minimized based on the bit length of the BF bit pattern, for example.

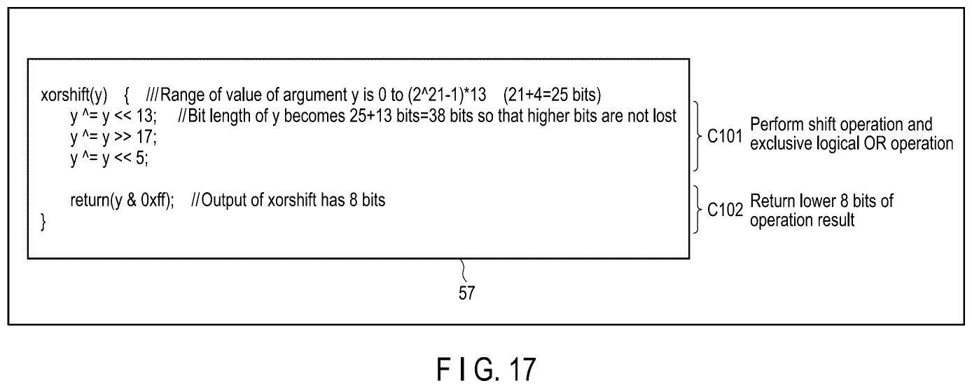

In the gen bf function 56, the wear management circuit 15-2 calculates three hash values hash0, hash1, and hash2 (B101). Specifically, the wear management circuit 15-2 calculates the hash value hash0 by using an xorshift function with an argument x. The wear management circuit 15-2 calculates the hash value hash1 by using the xorshift function with an argument (xx11). The wear management circuit 15-2 calculates the hash value hash2 by using the xorshift function with an argument (xx13). The xorshift function is a function that calculates a hash value based on an argument. A specific example of the xorshift function is described below with reference to FIG. 17.

Next, the wear management circuit 15-2 generates a BF bit pattern bf by using the calculated hash values hash0, hash1, and hash2, and returns the generated BF bit pattern bf to a caller of the gen bf function (B102). Specifically, the wear management circuit 15-2 performs an operation of shifting 1 to the left by the number of bits that corresponds to the hash value hash0, thereby acquiring a 0-th shift operation result. The wear management circuit 15-2 performs an operation of shifting 1 to the left by the number of bits that corresponds to the hash value hash1, thereby acquiring a first shift operation result. The wear management circuit 15-2 performs an operation of shifting 1 to the left by the number of bits that corresponds to the hash value hash2, thereby acquiring a second shift calculation result. Then, the wear management circuit 15-2 performs an OR operation of the 0-th shift operation result, the first shift operation result, and the second shift operation result, thereby generating the BF bit pattern bf.

By the gen bf function 56 described above, the wear management circuit 15-2 can generate the BF bit pattern corresponding to the argument x.

FIG. 17 illustrates an example of the xorshift function that is included in the gen bf function 56 of FIG. 16 and calculates a hash value. The xorshift function 57 calculates a hash value based on an argument y. The xorshift function 57 includes, for example, any shift operation and an exclusive logical OR (XOR) operation.

As described above, the argument x of the gen bf function 56 is, for example, the bit string in which the intra-group region ID and the word address are concatenated. Furthermore, in the example of the gen bf function 56 illustrated in FIG. 16, each of x, (xx11), and (xx13) becomes the argument y of the xorshift function 57. In this case, for example, in a case where the bit length of the argument x is 21 bits, a value range of the argument y is a range from 0 to ((221-1)×13). The bit length of the argument y capable of expressing the value range is 25 bits (=21±4). Then, as described below, in the xorshift function 57, an operation of shifting the argument y to the left by 13 bits is performed. Therefore, the bit length of the argument y is set to 38 bits (=25+13) so that upper bits are not lost by the shift operation.

In the xorshift function 57, the wear management circuit 15-2 performs shift operations and XOR operations that use the argument y (C101).

Specifically, first, the wear management circuit 15-2 performs an XOR operation on y and a value that is obtained by shifting y to the left by 13 bits, and sets the XOR operation result as y. Next, the wear management circuit 15-2 performs an XOR operation on y and a value that is obtained by shifting y to the right by 17 bits, and sets the XOR operation result as y. Furthermore, the wear management circuit 15-2 performs an XOR operation on y and a value that is obtained by shifting y to the left by 5 bits, and sets the XOR operation result as y.

Then, the wear management circuit 15-2 returns a bit string of lower 8 bits of y obtained as the above operation result, to a caller of the xorshift function 57 (C102). Specifically, the wear management circuit 15-2 performs an AND operation of y and “0xff”, thereby acquiring the bit string of lower 8 bits of y.

By the xorshift function 57 described above, the wear management circuit 15-2 can calculate the hash value corresponding to the argument y.

Next, a circuit configuration of the wear management circuit 15-2 for counting the degree of wear-out by using BF bit patterns will be described.

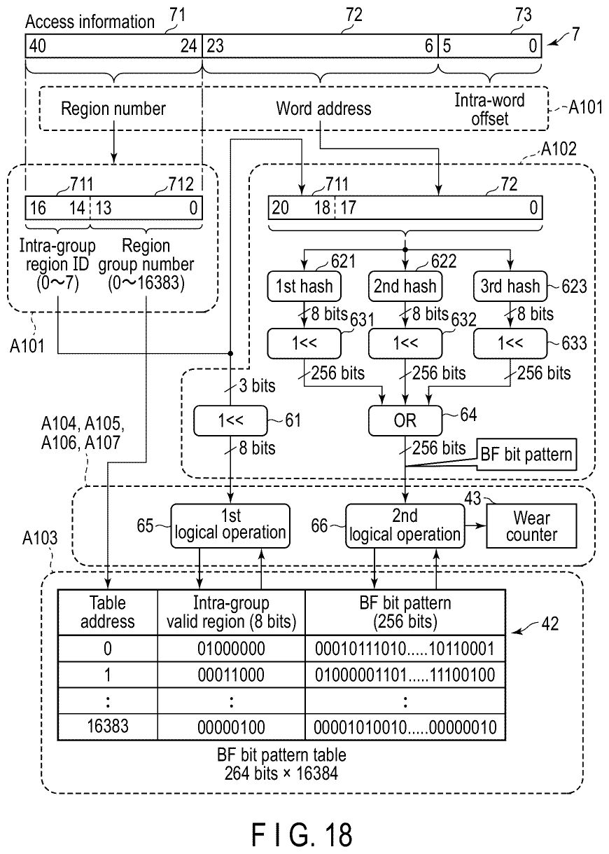

FIG. 18 is a block diagram illustrating an example of the circuit configuration of the wear management circuit 15-2. The circuit configuration of the wear management circuit 15-2 illustrated in FIG. 18 corresponds to the pseudo code 55 described above.

The wear management circuit 15-2 includes, for example, a valid bit shift operation unit 61, a first hash operation unit 621, a second hash operation unit 622, a third hash operation unit 623, a first shift operation unit 631, a second shift operation unit 632, a third shift operation unit 633, a logical OR (OR) operation unit 64, a first logical operation unit 65, a second logical operation unit 66, and the BF bit pattern table 42.

The access information 7 (checking target address) is input to the wear management circuit 15-2. The input of the access information 7 corresponds to A101 of the pseudo code 55.

The access information 7 includes a region number 71, a word address 72, and an intra-word offset 73. Here, as an example, it is assumed that the bit length of the access information 7 is 41 bits. In the access information 7, for example, the least significant bit is bit #0, the region number 71 is arranged in 17 bits from bit #40 to bit #24, the word address 72 is arranged in 18 bits from bit #23 to bit #6, and the intra-word offset 73 is arranged in 6 bits from bit #5 to bit #0.

The region number 71 includes an intra-group region ID 711 and a region group number 712. In the region number 71, for example, the intra-group region ID 711 is arranged in 3 bits from bit #16 to bit #14, and the region group number 712 is arranged in 14 bits from bit #13 to bit #0. The intra-group region ID 711 indicates, for example, any value from 0 to 7. The region group number 712 indicates, for example, any value from 0 to 16383.

The valid bit shift operation unit 61, the first hash operation unit 621, the second hash operation unit 622, the third hash operation unit 623, the first shift operation unit 631, the second shift operation unit 632, the third shift operation unit 633, and the OR operation unit 64 generate an intra-group valid bit and a BF bit pattern by using the intra-group region ID 711 and the word address 72. The generation of the in-group valid bit and the BF bit pattern corresponds to A102 of the pseudo code 55.

Specifically, the valid bit shift operation unit 61 acquires a bit string of 8 bits by performing an operation of shifting 1 to the left by the number of bits that corresponds to the intra-group region ID 711. That is, the valid bit shift operation unit 61 shifts 1 to the left by any number of bits from 0 bits to 7 bits. The acquired bit string of 8 bits is a bit string in which any one bit is 1 and the other 7 bits are 0. Therefore, the acquired bit string is a bit string indicative of a valid bit that corresponds to the intra-group region ID 711 (hereinafter, referred to as a valid bit string A). The valid bit shift operation unit 61 sends the valid bit string A to the first logical operation unit 65.

Each of the first hash operation unit 621, the second hash operation unit 622, and the third hash operation unit 623 performs a hash operation on a bit string in which the intra-group region ID 711 and the word address 72 are concatenated. The first hash operation unit 621, the second hash operation unit 622, and the third hash operation unit 623 perform operations using different hash functions, for example. Here, it is assumed that an 8-bit hash value is obtained with each hash operation. The first hash operation unit 621 sends the acquired hash value to the first shift operation unit 631. The second hash operation unit 622 sends the acquired hash value to the second shift operation unit 632. The third hash operation unit 623 sends the acquired hash value to the third shift operation unit 633.

The first shift operation unit 631 performs an operation of shifting 1 to the left by the number of bits that corresponds to the hash value received from the first hash operation unit 621, thereby acquiring a bit string of 256 bits (hereinafter, referred to as a first bit string). The first shift operation unit 631 sends the first bit string to the OR operation unit 64.

The second shift operation unit 632 performs an operation of shifting 1 to the left by the number of bits that corresponds to the hash value received from the second hash operation unit 622, thereby acquiring a bit string of 256 bits (hereinafter, referred to as a second bit string). The second shift operation unit 632 sends the second bit string to the OR operation unit 64.

The third shift operation unit 633 performs an operation of shifting 1 to the left by the number of bits that corresponds to the hash value received from the third hash operation unit 623, thereby acquiring a bit string of 256 bits (hereinafter, referred to as a third bit string). The third shift operation unit 633 sends the third bit string to the OR operation unit 64.

The OR operation unit 64 performs an OR operation on the first bit string, the second bit string, and the third bit string, thereby generating a BF bit pattern (BF bit pattern A). The OR operation unit 64 sends the BF bit pattern A to the second logical operation unit 66.

Furthermore, in the BF bit pattern table 42, a BF entry (target BF entry) that is identified by the region group number 712 as a table address is referred to. The reference to the BF entry in the BF bit pattern table 42 corresponds to A103 of the pseudo code 55.

The first logical operation unit 65 and the second logical operation unit 66 perform the duplicate access check by using the valid bit string A, the BF bit pattern A, and the target BF entry, and update the wear counter 43 and the target BF entry according to the result of the duplicate access check. The duplicate access check and the update of the wear counter 43 and the target BF entry correspond to A104 to A107 of the pseudo code 55.

The second logical operation unit 66 performs the duplicate access check by using the BF bit pattern A and the BF bit pattern (BF bit pattern B) in the target BF entry. Specifically, the second logical operation unit 66 determines whether or not a logical AND of the BF bit pattern A and the BF bit pattern B matches the BF bit pattern A. The logical AND matching the BF bit pattern A indicates that there is a possibility of duplicate access. The logical AND being different from the BF bit pattern A indicates that there is no possibility of duplicate access.

In a case where there is a possibility of duplicate access, the first logical operation unit 65 and the second logical operation unit 66 clear the target BF entry and increment the wear counter 43 of the region 23 identified by the region number 71. Specifically, the first logical operation unit 65 sets the valid bit string A in the intra-group valid region field of the target BF entry. The second logical operation unit 66 sets the BF bit pattern A in the BF bit pattern field of the target BF entry. Therefore, information indicative of a history of access to the corresponding region group set in the intra-group valid region field and the BF bit pattern field of the target BF entry is cleared, and the valid bit string A and the BF bit pattern A are overwritten. In addition, the second logical operation unit 66 (or the first logical operation unit 65) increments the wear counter 43 of the region 23 identified by the region number 71.

In a case where there is no possibility of duplicate access, the first logical operation unit 65 and the second logical operation unit 66 add information regarding the valid bit string A and the BF bit pattern A to the target BF entry. Specifically, the first logical operation unit 65 sets, in the intra-group valid region field of the target BF entry, a logical OR of the valid bit string A and the bit string (valid bit string B) that is set in the intra-group valid region field. The second logical operation unit 66 sets, in the BF bit pattern field of the target BF entry, a logical OR of the BF bit pattern A and the BF bit pattern B. In a case where the access to the region 23 identified by the region number 71 is the first access to the region 23 after the target BF entry is cleared, the second logical operation unit 66 (or the first logical operation unit 65) may increment the wear counter 43 of the region 23.

With the circuit configuration described above, the wear management circuit 15-2 can manage the degree of wear-out per region by using the BF bit pattern table 42.

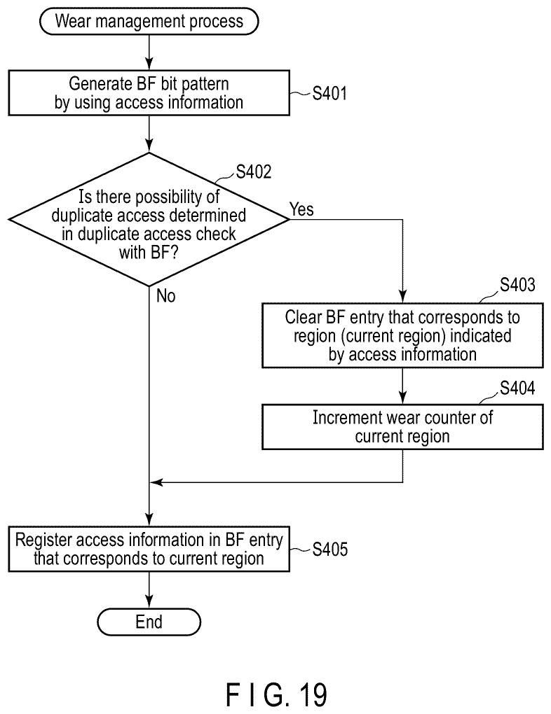

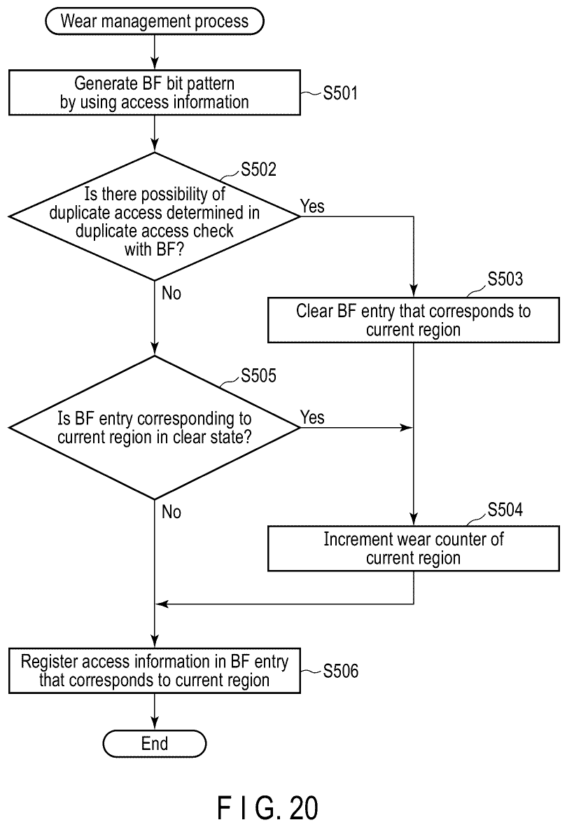

Next, processes executed in the memory system 3 will be described with reference to FIGS. 19 and 20.

FIG. 19 is a flowchart illustrating an example of a procedure of a wear management process executed by the wear management circuit 15-2. In the wear management process, in a case where it is determined that there is a possibility of duplicate access in the duplicate access check using the BF bit pattern table 42, the wear counter 43 of a corresponding region 23 is incremented. The wear management circuit 15-2 executes the wear management process in response to an input of the access information 7.

First, the wear management circuit 15-2 generates a BF bit pattern by using the input access information 7 (S401). It is assumed that the generated BF bit pattern is a BF bit pattern of L-bit-hot.

Next, the wear management circuit 15-2 determines whether or not there is a possibility that a matching address exists in the duplicate access check in which the generated BF bit pattern and the BF bit pattern table 42 are used (S402). Specifically, the wear management circuit 15-2 identifies a BF entry in the BF bit pattern table 42 that corresponds to a region 23 (current region 23) indicated by the access information 7. The wear management circuit 15-2 calculates a logical AND of the generated BF bit pattern and the BF bit pattern in the identified BF entry. In a case where the number of bits of 1 in a bit string of the logical AND is L, the wear management circuit 15-2 determines that there is a possibility that a matching address exists. In a case where the number of bits of 1 in the bit string of the logical AND is smaller than L, the wear management circuit 15-2 determines that there is no possibility that a matching address exists. The wear management circuit 15-2 may determine whether or not there is a possibility that a matching address exists, depending on whether or not the generated BF bit pattern matches the calculated logical AND. That is, in a case where the generated BF bit pattern matches the calculated logical AND, the wear management circuit 15-2 determines that there is a possibility that a matching address exists. In a case where the generated BF bit pattern is different from the calculated logical AND, the wear management circuit 15-2 determines that there is no possibility that a matching address exists.

In a case where there is no possibility that a matching address exists (No in S402), the process proceeds to S405.

In a case where there is a possibility that a matching address exists (Yes in S402), the wear management circuit 15-2 clears the BF entry in the BF bit pattern table 42 that corresponds to the region 23 (current region 23) indicated by the access information 7 (S403). Specifically, the wear management circuit 15-2 sets a bit string in which all bits are 0 in the BF bit pattern field of the BF entry. Note that in a case where the BF entry further includes the intra-group valid region field, the wear management circuit 15-2 sets a bit string in which all bits are 0 in the intra-group valid region field. Then, the wear management circuit 15-2 increments the wear counter 43 of the current region 23 (S404), and the process proceeds to S405.

Next, the wear management circuit 15-2 registers the access information 7 in the BF entry corresponding to the current region 23 (S405). Specifically, the wear management circuit 15-2 calculates a logical OR of the BF bit pattern set in the BF entry corresponding to the current region 23 and the BF bit pattern generated in S401. Then, the wear management circuit 15-2 sets the calculated logical OR as the BF bit pattern of the BF entry. In a case where the BF entry further includes the intra-group valid region field, the wear management circuit 15-2 sets a bit corresponding to the current region 23 among the bit string of the intra-group valid region field, to the valid bit (for example, 1). Then, the wear management circuit 15-2 ends the wear management process.

Through the wear management process described above, the wear management circuit 15-2 manages the degree of wear-out per region. The wear management circuit 15-2 checks the presence or absence of the possibility of duplicate access, based on the BF bit pattern generated from the access information 7 and the BF bit pattern of the BF entry corresponding to the current region 23 in the BF bit pattern table 42, and determines necessity of incrementing the wear counter 43. As a result, the wear management circuit 15-2 can eliminate the pessimism for the degree of wear-out per region. Specifically, in a case where there is a possibility of duplicate access, the wear management circuit 15-2 increments the wear counter 43 of the current region 23. In a case where there is no possibility of duplicate access, the wear management circuit 15-2 does not increment the wear counter 43 of the current region 23. Therefore, the wear management circuit 15-2 can eliminate the pessimism for the degree of wear-out per region by using the BF bit pattern table 42.

As another example of the procedure of the wear management process, the wear management circuit 15-2 may increment the wear counter 43 of a region 23 in the case of newly adding (registering) information corresponding to the region 23 to a BF entry in which information corresponding to the region 23 is cleared.

FIG. 20 is a flowchart illustrating another example of the procedure of the wear management process executed by the wear management circuit 15-2. In the wear management process, the wear counter 43 of a corresponding region 23 is incremented (1) in a case where it is determined that there is a possibility of duplicate access in the duplicate access check using the BF bit pattern table 42 and (2) in a case where information corresponding to the region 23 is newly added to a BF entry in which information corresponding to the region 23 is cleared. The wear management circuit 15-2 executes the wear management process in response to an input of the access information 7. Some processes in the flowchart of FIG. 20 are the same as the some processes in the flowchart of FIG. 19, respectively.

Processes from S501 to S504 in FIG. 20 are similar to the processes from S401 to S404 in FIG. 19 described above.

In the duplicate access check in which the BF bit pattern generated by using the access information 7 and the BF bit pattern table 42 are used, in a case where there is no possibility of duplicate access (No in S502), the wear management circuit 15-2 determines whether or not the BF entry corresponding to the current region 23 is in a clear state (S505). Specifically, in a case where the BF bit pattern table 42 includes the BF entry for each region, the wear management circuit 15-2 determines whether or not the BF bit pattern is in the clear state in the BF entry corresponding to the current region 23. In a case where the BF bit pattern table 42 includes the BF entry for each region group, the wear management circuit 15-2 determines whether or not a bit of the intra-group valid region field corresponding to the current region 23 is in the clear state (for example, 0) or determines whether or not the BF bit pattern is in the clear state in the BF entry corresponding to a region group to which the current region 23 belongs.

In a case where the BF entry corresponding to the current region 23 is not in the clear state (No in S505), the process proceeds to S506.

In a case where the BF entry corresponding to the current region 23 is in the clear state (Yes in S505), the wear management circuit 15-2 increments the wear counter 43 of the current region 23 (S504), and the process proceeds to S506.

Next, the wear management circuit 15-2 registers the access information 7 in the BF entry corresponding to the current region 23 (S506), and ends the wear management process. The process of S506 of FIG. 20 is similar to the process of S405 of FIG. 19 described above.

Through the wear management process described above, the wear management circuit 15-2 manages the degree of wear-out per region. The wear management circuit 15-2 checks the presence or absence of the possibility of duplicate access, based on the BF bit pattern generated from the access information 7 and the BF bit pattern of the BF entry corresponding to the current region 23 in the BF bit pattern table 42, and determines necessity of incrementing the wear counter 43. As a result, the wear management circuit 15-2 can eliminate the pessimism for the degree of wear-out per region. Specifically, in a case where there is a possibility of duplicate access, the wear management circuit 15-2 increments the wear counter 43 of the current region 23. In addition, in a case where there is no possibility of duplicate access and the BF entry corresponding to the current region 23 is in the clear state, the wear management circuit 15-2 increments the wear counter 43 of the current region 23. In a case where there is no possibility of duplicate access and the BF entry corresponding to the current region 23 is not in the clear state, the wear management circuit 15-2 does not increment the wear counter 43 of the current region 23. Therefore, the wear management circuit 15-2 can eliminate the pessimism for the degree of wear-out per region by using the BF bit pattern table 42.

As described above, in the memory system 3 of the second embodiment, it is possible to maintain the processing performance while eliminating the pessimism for the degree of wear-out per region by using the BF bit pattern table 42.

### Third Embodiment

The memory system 3 according to the first embodiment determines whether or not there is a possibility of duplicate access to a current address on the basis of the access log 32 that indicates a history of past addresses. The memory system 3 according to the second embodiment determines the presence or absence of the possibility of duplicate access to a current address on the basis of the BF bit pattern table 42 that indicates a BF bit pattern for each region.

On the other hand, in determination of a presence or absence of a possibility of duplicate access in a memory system 3 according to a third embodiment, a BF bit pattern table 82 configured to increase the bit length of each BF bit pattern is used instead of reducing the number of entries as compared with the BF bit pattern table 42 of the second embodiment. The memory system 3 of the third embodiment determines whether or not there is a possibility of duplicate access to a current address, based on the BF bit pattern table 82 in which the number of entries is relatively small and the bit length of each BF bit pattern is relatively long. In the memory system 3 of the third embodiment, since two BF bit patterns are compared as in the second embodiment, for example, it is not necessary to compare one BF bit pattern with each of a plurality of BF bit patterns in the BF bit pattern table 82 in parallel.

A configuration of the memory system 3 of the third embodiment is similar to those of the memory systems 3 of the first and second embodiments. The memory system 3 of the third embodiment is different from those of the first and second embodiments in terms of a process of determining whether or not there is a possibility of duplicate access on the basis of the BF bit pattern table 82 in which the number of entries is relatively small and the bit length of each BF bit pattern is relatively long instead of the access log 32 or the BF bit pattern table 42. Hereinafter, the differences from the first and second embodiments will be mainly described.

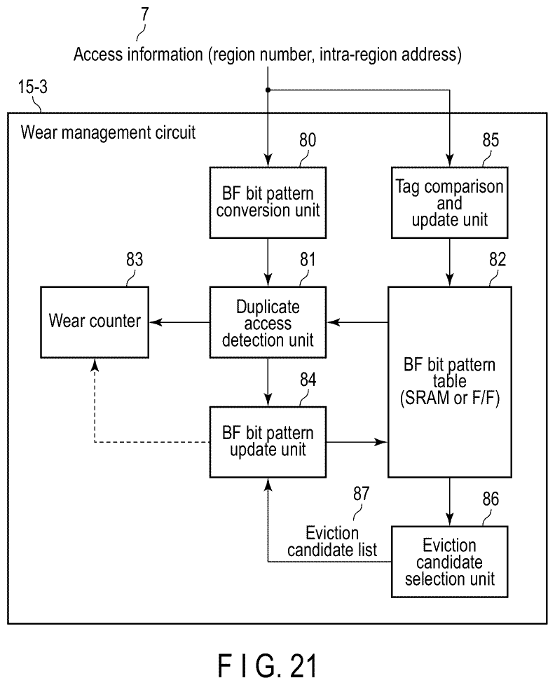

FIG. 21 is a block diagram illustrating a configuration example of a wear management circuit 15-3 of the memory system 3 according to the third embodiment. The configuration of the memory system 3 according to the third embodiment corresponds to, for example, a configuration in which the wear management circuit 15 in the memory system 3 according to the first embodiment described above with reference to FIG. 1 is replaced with the wear management circuit 15-3.

The wear management circuit 15-3 is a circuit for managing a degree of wear-out of a nonvolatile memory 4. Specifically, the wear management circuit 15-3 manages the degree of wear-out of the nonvolatile memory 4 for each region by using access information 7 received from an access processing module 141 and a BF bit pattern indicative of a history of past access to addresses included in each region 23.

The access information 7 is input to the wear management circuit 15-3 in response to access to the nonvolatile memory 4. The wear management circuit 15-3 includes, for example, a BF bit pattern conversion unit 80, a duplicate access detection unit 81, the BF bit pattern table 82, a wear counter 83 for each region, a BF bit pattern update unit 84, a tag comparison and update unit 85, and an eviction candidate selection unit 86.

The BF bit pattern conversion unit 80 converts an address (current address) indicated in the access information 7 into a BF bit pattern (hereinafter, also referred to as a BF bit pattern E). For example, the BF bit pattern E has a bit length longer than the bit length of the BF bit pattern A generated by the BF bit pattern conversion unit 40 of the wear management circuit 15-2 in the second embodiment. For example, in a case where the bit length of the BF bit pattern A is 256 bits, the bit length of the BF bit pattern E is 512 bits. A specific method of generating the BF bit pattern E is similar to the method described above in the second embodiment. The BF bit pattern conversion unit 80 sends the BF bit pattern E to the duplicate access detection unit 81.

The tag comparison and update unit 85 identifies a BF entry in the BF bit pattern table 82 that corresponds to a region number included in the access information 7 (hereinafter, also referred to as a region number E) by using the region number E as a tag. For example, in a case where the BF bit pattern table 82 includes a plurality of valid entries, the tag comparison and update unit 85 determines whether or not the BF bit pattern table 82 includes a valid entry that includes the same region number as the region number E, for example, by comparing the region number E with a region number of each of the plurality of valid entries in parallel. In other words, the tag comparison and update unit 85 determines whether or not the plurality of valid entries include a BF bit pattern corresponding to a region 23 (current region 23) of the region number E by using the region number E.

In a case where the BF bit pattern table 82 includes the valid entry that includes the same region number as the region number E, the tag comparison and update unit 85 identifies the valid entry as a BF entry (target BF entry) corresponding to the region number E. A BF bit pattern in the target BF entry (hereinafter, also referred to as a BF bit pattern F) is read (sent) from the BF bit pattern table 82 to the duplicate access detection unit 81.

In a case where the BF bit pattern table 82 does not include any valid entry that includes the same region number as the region number E, the tag comparison and update unit 85 determines that the BF bit pattern table 82 does not include any BF entry corresponding to the region number E. In this case, for example, no BF bit pattern is read from the BF bit pattern table 82 to the duplicate access detection unit 81.

The duplicate access detection unit 81 performs a duplicate access check based on the BF bit pattern E received from the BF bit pattern conversion unit 80 and the BF bit pattern table 82. Specifically, in a case where the BF bit pattern F has been transmitted from the BF bit pattern table 82 to the duplicate access detection unit 81, the duplicate access detection unit 81 determines whether or not there is a possibility that the current access is duplicate access by comparing the BF bit pattern F with the BF bit pattern E. That is, the duplicate access detection unit 81 determines whether or not there is a possibility that the current address is included in one or more addresses converted into the BF bit pattern F, by using the BF bit pattern F and the BF bit pattern E. On the basis of the result of the determination, the duplicate access detection unit 81 determines whether or not to increase a degree of wear-out of the current region 23.

On the other hand, in a case where none of the BF bit patterns is sent from the BF bit pattern table 82 to the duplicate access detection unit 81, the duplicate access detection unit 81 determines that there is no possibility that the current access is duplicate access.

In a case where there is a possibility that the current access is duplicate access, the duplicate access detection unit 81 sends an increment instruction for the degree of wear-out of the current region 23 to the wear counter 83. In addition, the duplicate access detection unit 81 sends, to the BF bit pattern update unit 84, the determination result of the duplicate access check (that is, the determination result indicating whether or not there is a possibility that the current access is duplicate access), the access information 7, and the BF bit pattern E. In a case where the BF bit pattern F has been transmitted from the BF bit pattern table 82, the duplicate access detection unit 81 further sends the BF bit pattern F to the BF bit pattern update unit 84.

The BF bit pattern table 82 is data that represents a history of access to each of a maximum of M regions 23 with a BF bit pattern. M is an integer of one or more, and is, for example, smaller than the number Q of regions 23 managed by the memory system 3. M is, for example, 32.

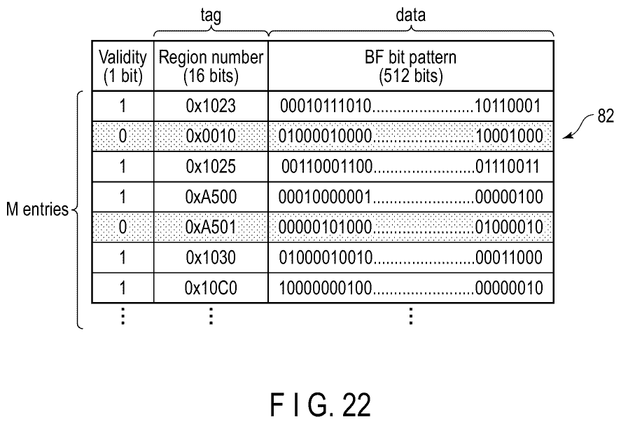

As described above, for example, the tag comparison and update unit 85 compares the region number E with each of the region numbers of one or more valid entries included in the BF bit pattern table 82 in parallel, thereby identifying the target BF entry that includes the same region number as the region number E. Then, the duplicate access detection unit 81 performs the duplicate access check by comparing the BF bit pattern E with the BF bit pattern F in the target BF entry. In this manner, in the memory system 3 of the third embodiment, it is not necessary to compare the BF bit pattern E with each of the plurality of BF bit patterns in the BF bit pattern table 82 in parallel. Therefore, the BF bit pattern table 82 may be implemented with either F/F circuits or an SRAM. A correspondence between each region number and each BF bit pattern is managed by, for example, a content addressable memory (CAM). By the CAM, for example, a storage location of a BF bit pattern is acquired with a corresponding region number as a key. A specific configuration example of the BF bit pattern table 82 is described below with reference to FIG. 22.

The wear counter 83 is similar to the wear counter 33 of the wear management circuit 15 in the first embodiment.

The BF bit pattern update unit 84 updates the BF bit pattern table 82 by using the determination result of the duplicate access check, the access information 7, and the BF bit pattern E that have been received from the duplicate access detection unit 81. The BF bit pattern update unit 84 may further receive the BF bit pattern F from the duplicate access detection unit 81. The BF bit pattern update unit 84 registers the access information 7 in the BF bit pattern table 82 according to the determination result of the duplicate access check.

Specifically, in a case where the determination result of the duplicate access check indicates that there is a possibility that the current access is duplicate access, the BF bit pattern update unit 84 deletes, in the BF bit pattern table 82, the BF entry (target BF entry) corresponding to the current region 23 based on the access information 7. The deleted target BF entry becomes an invalid entry.

Then, the BF bit pattern update unit 84 sets (overwrites) information that indicates a valid bit, the current region 23, and the BF bit pattern E, in any invalid entry in the BF bit pattern table 82.

In a case where the determination result of the duplicate access check indicates that there is no possibility that the current access is duplicate access and the BF bit pattern F has been received from the duplicate access detection unit 81, the BF bit pattern update unit 84 sets a logical OR of the BF bit pattern E and the BF bit pattern F, in the BF entry that corresponds to the current region 23 in the BF bit pattern table 82. In a case where the determination result of the duplicate access check indicates that there is no possibility that the current access is duplicate access and the BF bit pattern F is not received from the duplicate access detection unit 81, the BF bit pattern update unit 84 sets the information that indicates the valid bit, the current region 23, and the BF bit pattern E, in any invalid entry in the BF bit pattern table 82.

Note that in a case where the BF bit pattern table 82 is full, the BF bit pattern update unit 84 determines a region 23 to be evicted (eviction target region 23) from the BF bit pattern table 82 by using an eviction candidate list 87. The eviction candidate list 87 is a list indicative of one or more candidates of the region 23 to be evicted (eviction candidate regions 23). A specific configuration example of the eviction candidate list 87 is similar to the eviction candidate list 37 of the first embodiment described above with reference to FIG. 8. The BF bit pattern update unit 84 deletes a BF entry corresponding to the eviction target region 23 from the BF bit pattern table 82. That is, the BF bit pattern update unit 84 invalidates the valid BF entry that corresponds to the eviction target region 23 in the BF bit pattern table 82. Note that the BF bit pattern update unit 84 may send an increment instruction for the degree of wear-out of the eviction target region 23 to the wear counter 83.

The eviction candidate selection unit 86 is similar to the eviction candidate selection unit 36 of the wear management circuit 15 in the first embodiment.

FIG. 22 illustrates a configuration example of the BF bit pattern table 82. The BF bit pattern table 82 includes a maximum of M entries. The M entries correspond to the M regions 23, respectively. Each of the M entries includes, for example, a validity field, a region number field, and a BF bit pattern field.

In an entry corresponding to a region 23, the validity field indicates whether or not the entry is valid. In the BF bit pattern table 82, entries illustrated with dot patterns represent invalid entries.

The region number field indicates a number (region number) assigned to the corresponding region 23. The bit length of the region number field is, for example, 16 bits. The region number set in the region number field is used as a tag for identifying an entry in the BF bit pattern table 82 that corresponds to the region number included in the access information 7.

The BF bit pattern field indicates a BF bit pattern generated based on a history of access to addresses included in the corresponding region 23. The bit length of the BF bit pattern field is, for example, 512 bits. The BF bit pattern (BF bit pattern F) set in the BF bit pattern field is used, for the duplicate access check, as target data to be compared with the BF bit pattern (BF bit pattern E) generated by using the access information 7.

In response to access to an address in the corresponding region 23, the presence or absence of the possibility of duplicate access is detected by using a BF bit pattern (BF bit pattern E) converted from the address and the BF bit pattern (BF bit pattern F) set in the BF bit pattern field. In a case where the possibility of duplicate access is not detected, a logical OR of the BF bit pattern E and the BF bit pattern F is newly set in the BF bit pattern field. In a case where the possibility of duplicate access has been detected, the BF bit pattern field is cleared, for example. Note that in a case where the duplicate access has been detected, an invalid bit (for example, 0) is set in the validity field in addition to or instead of the BF bit pattern field being cleared.

In the example illustrated in FIG. 22, an entry corresponding to a region 23 with a region number “0×1023” is a valid entry, and a BF bit pattern “00010111010 . . . 10110001” is set in the entry. In addition, an entry corresponding to a region 23 with a region number “0×0010” is an invalid entry.

The BF bit pattern table 42 of the second embodiment includes, for example, the same number of entries as the number Q of regions 23 managed by the memory system 3. On the other hand, in the BF bit pattern table 82 of the third embodiment, the number of entries is reduced to be smaller than the number Q of the regions 23 managed by the memory system 3, but the bit length of each BF bit pattern is increased to be longer than that of the BF bit pattern table 42 of the second embodiment. As a result, a false positive occurrence probability in the duplicate access check using the BF bit patterns can be reduced, and a data amount of information managed for performing the duplicate access check can be reduced.

In the memory system 3 of the third embodiment, since the false positive occurrence probability is reduced, a presented life of the memory system 3 can be further improved. An improvement rate of the presented life is substantially proportional to the bit length of each BF bit pattern. For example, in a case where the bit length of each BF bit pattern is 512 bits, the improvement rate of the presented life is about 80 (about 8000%) at the maximum as compared with a case where the BF bit pattern table 82 is not used.

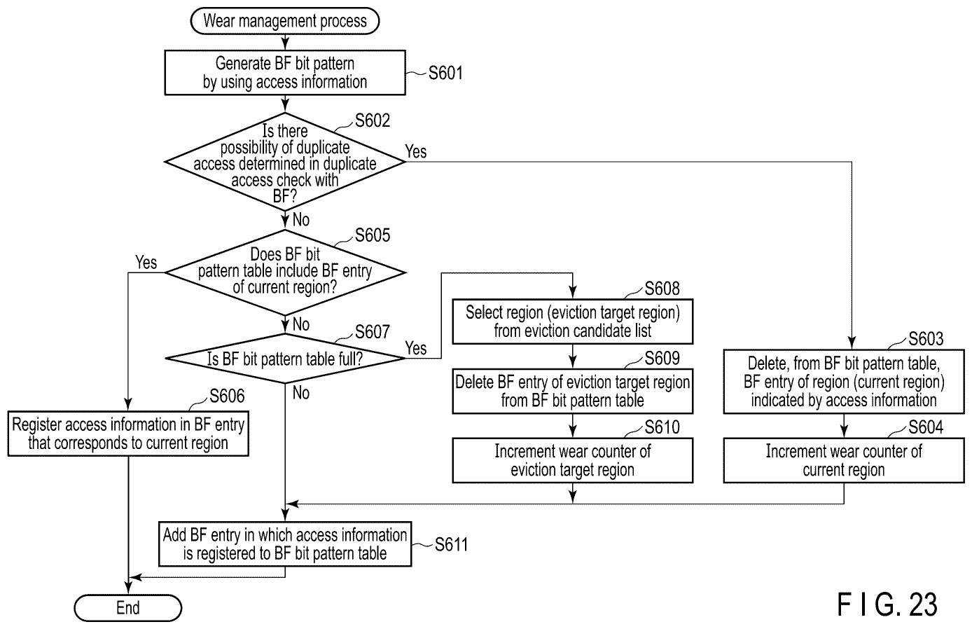

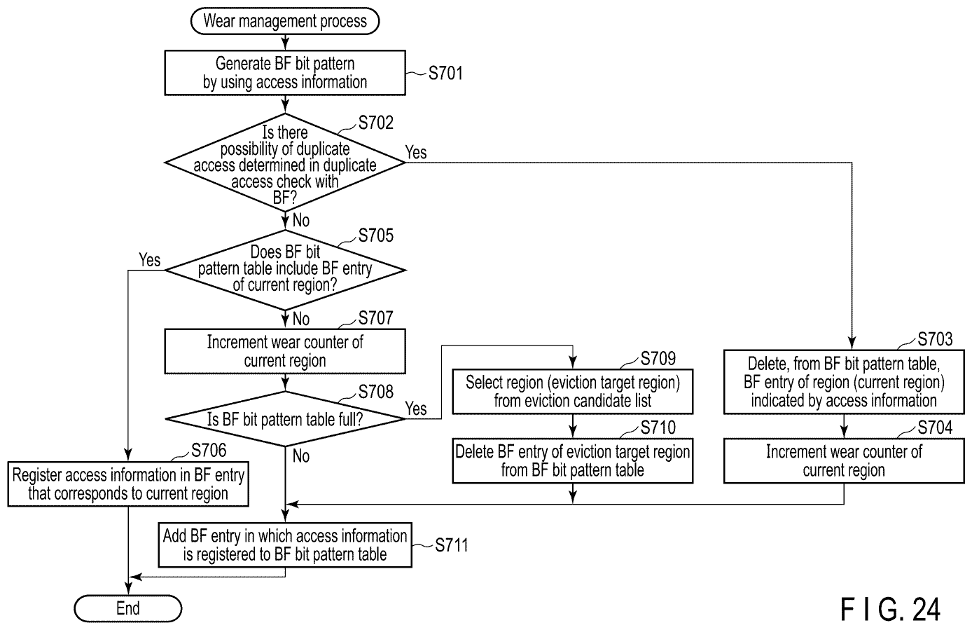

Next, processes executed in the memory system 3 of the third embodiment will be described with reference to FIGS. 23 and 24.

FIG. 23 is a flowchart illustrating an example of a procedure of a wear management process executed in the wear management circuit 15-3. In the wear management process, in a case where it is determined that there is a possibility of duplicate access in the duplicate access check using the BF bit pattern table 82, the wear counter 83 of a corresponding region 23 is incremented. The wear management circuit 15-3 executes the wear management process in response to an input of the access information 7. Some processes in the flowchart of FIG. 23 are the same as some processes in the flowchart of FIG. 19.

Processes of S601 and S602 of FIG. 23 correspond to processes in which the BF bit pattern table 42 is replaced with the BF bit pattern table 82 in the processes of S401 and S402 of FIG. 19.

In the duplicate access check in which a BF bit pattern generated by using the access information 7 and the BF bit pattern table 82 are used, in a case where there is a possibility that the current access is duplicate access (Yes in S602), the wear management circuit 15-3 deletes, from the BF bit pattern table 82, the BF entry corresponding to the region 23 (current region 23) indicated in the access information 7 (S603). Specifically, the wear management circuit 15-3 changes the valid bit of the BF entry corresponding to the current region 23 to the invalid bit (for example, 0). Then, the wear management circuit 15-3 increments the wear counter 83 of the current region 23 (S604), and the process proceeds to S611.

In the duplicate access check in which the BF bit pattern generated by using the access information 7 and the BF bit pattern table 82 are used, in a case where there is no possibility that the current access is duplicate access (No in S602), the wear management circuit 15-3 determines whether or not the BF bit pattern table 82 includes a BF entry corresponding to the current region 23 (S605).

In a case where the BF bit pattern table 82 includes the BF entry corresponding to the current region 23 (Yes in S605), the wear management circuit 15-3 registers the access information 7 in the BF entry (S606). That is, the wear management circuit 15-3 calculates a logical OR of the BF bit pattern in the BF entry and the generated BF bit pattern. The wear management circuit 15-3 sets the calculated logical OR as the BF bit pattern in the BF entry. Then, the wear management circuit 15-3 ends the wear management process.

In a case where the BF bit pattern table 82 does not include any BF entry corresponding to the current region 23 (No in S605), the wear management circuit 15-3 determines whether or not the BF bit pattern table 82 is full (S607). That is, the wear management circuit 15-3 determines whether or not the number of valid BF entries included in the BF bit pattern table 82 matches the maximum number M of entries that can be stored in the BF bit pattern table 82.

In a case where the BF bit pattern table 82 is not full (includes a free entry) (No in S607), the process proceeds to S611.

In a case where the BF bit pattern table 82 is full (Yes in S607), the wear management circuit 15-3 selects a region 23 (eviction target region 23) from the eviction candidate list 87 (S608). The wear management circuit 15-3 deletes the BF entry corresponding to the eviction target region 23 from the BF bit pattern table 82 (S609). Specifically, the wear management circuit 15-3 sets the invalid bit in the BF entry corresponding to the eviction target region 23, thereby changing the BF entry to an invalid entry. Then, the wear management circuit 15-3 increments the wear counter 83 of the eviction target region 23 (S610), and the process proceeds to S611.

Next, the wear management circuit 15-3 adds a BF entry in which the access information 7 is registered to the BF bit pattern table 82 (S611). Specifically, the wear management circuit 15-3 adds, for example, the BF entry in which the valid bit, the region number included in the access information 7, and the generated BF bit pattern are set, to the BF bit pattern table 82. Alternatively, the wear management circuit 15-3 overwrites an invalid entry in the BF bit pattern table 82 with the valid bit, the region number included in the access information 7, and the generated BF bit pattern. Then, the wear management circuit 15-3 ends the wear management process.

Through the wear management process described above, the wear management circuit 15-3 manages the degree of wear-out per region. The wear management circuit 15-3 checks the presence or absence of the possibility of duplicate access, based on the BF bit pattern generated from the access information 7 and the BF bit pattern of the BF entry corresponding to the current region 23 and determines necessity of incrementing the wear counter 83. As a result, the wear management circuit 15-3 can eliminate the pessimism for the degree of wear-out per region. Specifically, in a case where there is a possibility of duplicate access, the wear management circuit 15-3 increments the wear counter 83 of the current region 23. In a case where there is no possibility of duplicate access and the BF bit pattern table 82 is full, the wear management circuit 15-3 increments the wear counter 83 of the eviction target region 23. In addition, in a case where there is no possibility of duplicate access and the BF bit pattern table 82 is not full, the wear management circuit 15-3 does not increment the wear counter 83 of any of the regions 23. Therefore, the wear management circuit 15-3 can eliminate the pessimism for the degree of wear-out per region by using the BF bit pattern table 82.

In the wear management process of FIG. 23 described above, the wear management circuit 15-3 increments the wear counter 83 of the eviction target region 23. As another example of the procedure of the wear management process, in the case of newly adding (registering) a BF entry corresponding to a region 23 to the BF bit pattern table 82 that does not include a valid BF entry corresponding to the region 23, the wear management circuit 15-3 may increment the wear counter 83 of the region 23.

FIG. 24 is a flowchart illustrating another example of the procedure of the wear management process executed in the wear management circuit 15-3. In the wear management process, the wear counter 83 of the corresponding region 23 is incremented (1) in a case where it is determined that there is a possibility that a matching address is accessed in the duplicate access check using the BF bit pattern table 82 and (2) in a case where a BF entry corresponding to a region 23 is newly added to the BF bit pattern table 82 that does not include a valid BF entry corresponding to the region 23. The wear management circuit 15-3 executes the wear management process in response to an input of the access information 7. Some processes in the flowchart of FIG. 24 are the same as some processes in the flowchart of FIG. 23.

Processes from S701 to S706 of FIG. 24 are similar to the processes from S601 to S606 in FIG. 23 described above.

In a case where the BF bit pattern table 82 does not include any BF entry corresponding to a region 23 (current region 23) indicated in the access information 7 (No in S705), the wear management circuit 15-3 increments the wear counter 83 of the current region 23 (S707). Subsequent processes from S708 to S711 are similar to the processes of S607, S608, S609, and S611 of FIG. 23 described above. That is, the processes from S708 to S711 correspond to processes in which the process of S610 of incrementing the wear counter 83 of the eviction target region 23 is excluded from the processes from S607 to S611 of FIG. 23.

Through the wear management process described above, the wear management circuit 15-3 manages the degree of wear-out per region. The wear management circuit 15-3 checks the presence or absence of the possibility of duplicate access, based on the BF bit pattern generated from the access information 7 and the BF bit pattern of the BF entry corresponding to the current region 23, and determines the necessity of incrementing the wear counter 83. As a result, the wear management circuit 15-3 can eliminate the pessimism for the degree of wear-out per region. Specifically, in a case where there is a possibility of duplicate access, the wear management circuit 15-3 increments the wear counter 83 of the current region 23. In a case where there is no possibility of duplicate access and the BF bit pattern table 82 does not include any BF entry corresponding to the current region 23, the wear management circuit 15-3 increments the wear counter 83 of the current region 23. In addition, in a case where there is no possibility of duplicate access and the BF bit pattern table 82 includes the BF entry corresponding to the current region 23, the wear management circuit 15-3 does not increment the wear counter 83 of the current region 23. Therefore, the wear management circuit 15-3 can eliminate the pessimism for the degree of wear-out per region by using the BF bit pattern table 82.

Therefore, in the memory system 3 of the third embodiment, it is possible to maintain processing performance while eliminating the pessimism for the degree of wear-out per region by using the BF bit pattern table 82.

As described above, according to the first to third embodiments, it is possible to maintain the processing performance while eliminating the pessimism for the degree of wear-out.

The configurations and operations of the first to third embodiments described above are summarized as below. The nonvolatile memory 4 includes a plurality of access units 22. The access processing module 141 performs access to the nonvolatile memory 4 for each access unit 22. The wear counter 43 manages a degree of wear-out of the nonvolatile memory 4 for each wear management unit (for example, for each region 23) that includes P access units 22 among the plurality of access units 22. The BF bit pattern conversion unit 40 and the BF bit pattern update unit 44 convert one or more addresses (for example, intra-region addresses) into first data (BF bit pattern). The one or more addresses indicate one or more accessed access units 22, respectively, among P access units 22 that are included in each of Q wear management units (for example, Q regions 23 or Q region groups). The BF bit pattern table 42 manages Q pieces of first data that correspond to the Q wear management units, respectively. The access processing module 141 accesses a first access unit 22 among the P access units that are included in a first wear management unit among the Q wear management units. The BF bit pattern conversion unit 40 converts a first address indicative of the first access unit 22 into second data (BF bit pattern). The duplicate access detection unit 41 makes a determination as to whether there is a possibility that the first address is included in the one or more addresses converted into the first data that corresponds to the first wear management unit by using the first data corresponding to the first wear management unit and the second data. Based on the result of the determination, the duplicate access detection unit 41 determines whether or not to increase the degree of wear-out of the first wear management unit. The bit length of the first data is the same as the bit length of the second data. P is an integer of two or more. Q is an integer of one or more.

With the above configuration, in the BF bit pattern table 42, a history of access for each wear management unit is managed as the first data. The duplicate access detection unit 41 makes the determination as to whether access to the first access unit 22 (first address) is duplicate access by using the first data corresponding to the first wear management unit, which includes the first access unit 22, and the second data. Then, based on the result of the determination, the duplicate access detection unit 41 determines whether or not to increase the degree of wear-out of the first wear management unit. As a result, in the memory system 3, the pessimism for the degree of wear-out for each wear management unit can be eliminated, and the processing performance can be maintained.

Each of the various functions described in the first to third embodiments may be realized by a circuit (e.g., processing circuit). An exemplary processing circuit may be a programmed processor such as a central processing unit (CPU). The processor executes computer programs (instructions) stored in a memory thereby performs the described functions. The processor may be a microprocessor including an electric circuit. An exemplary processing circuit may be a digital signal processor (DSP), an application specific integrated circuit (ASIC), a microcontroller, a controller, or other electric circuit components. The components other than the CPU described according to the embodiments may be realized in a processing circuit.

While certain embodiments have been described, these embodiments have been presented by way of example only, and are not intended to limit the scope of the inventions. Indeed, the novel devices and methods described herein may be embodied in a variety of other forms; furthermore, various omissions, substitutions and changes in the form of the embodiments described herein may be made without departing from the spirit of the inventions. The accompanying claims and their equivalents are intended to cover such forms or modification as would fall within the scope and spirit of the inventions.

What is claimed is:

1. A memory system comprising:
a nonvolatile memory that includes a plurality of access units; and
a controller electrically connected to the nonvolatile memory and configured to:
perform access to the nonvolatile memory for each access unit; and
manage a degree of wear-out of the nonvolatile memory for each wear management unit that includes P access units among the plurality of access units, wherein
the controller is configured to:
manage Q pieces of first data that correspond to Q wear management units, respectively, the first data being data into which one or more addresses are converted, the one or more addresses respectively indicating one or more access units accessed among the P access units in each of the Q wear management units;
access a first access unit among the P access units that are included in a first wear management unit among the Q wear management units;
convert a first address indicative of the first access unit into second data;
make a first determination as to whether there is a possibility that the first address is included in the one or more addresses converted into the first data corresponding to the first wear management unit among the managed Q pieces of first data by using the first data corresponding to the first wear management unit and the second data; and
determine whether or not to increase a degree of wear-out of the first wear management unit, based on 1a result of the first determination,
a bit length of the first data is same as a bit length of the second data,
P is an integer of two or more, and
Q is an integer of one or more.

2. The memory system according to claim 1, wherein
a data amount of the first data does not depend on a number of the one or more addresses.

3. The memory system according to claim 1, wherein
the controller is further configured
to increase the degree of wear-out of the first wear management unit in a case where it is determined that there is a possibility that the one or more addresses include the first address, and
not to increase the degree of wear-out of the first wear management unit in a case where it is determined that there is no possibility that the one or more addresses include the first address.

4. The memory system according to claim 1, wherein
P addresses indicate the P access units,
respectively, and are contiguous addresses in an address space that is managed in the memory system.

5. The memory system according to claim 1, wherein
the controller is further configured to:
manage (Q/R) pieces of third data that correspond to (Q/R) groups, R wear management units among the Q wear management units respectively belonging to each of the (Q/R) groups, the third data being data into which one or more addresses that respectively indicate one or more access units accessed among (R×P) access units are converted, the (R×P) access units being included in the R wear management units;
access a second access unit included in a second wear management unit that belongs to a first group among the (Q/R) groups;
convert a second address indicative of the second access unit into fourth data;
make a second determination as to whether there is a possibility that the second address is included in the one or more addresses converted into the third data corresponding to the first group among the managed (Q/R) pieces of third data by using the third data corresponding to the first group and the fourth data; and
determine whether or not to increase a degree of wear-out of the second wear management unit, based on a result of the second determination, and
R is an integer of Q or less.

6. The memory system according to claim 5, wherein
(R×P) addresses indicate the (R×P) access units, respectively, and include scattered addresses in an address space that is managed in the memory system.

7. The memory system according to claim 1, wherein
the controller is further configured to use a bloom filter for the first determination.

8. The memory system according to claim 1, wherein
the controller is further configured to:
convert the one or more addresses into one or more bit strings, respectively, by using one or more hash functions;
generate a logical OR of the one or more bit strings as the first data; and
generate, as the second data, a first bit string into which the first address is converted by using the one or more hash functions.

9. The memory system according to claim 1, wherein
a second wear management unit includes the P access units among the plurality of access units, and is one of M wear management units,
the controller is further configured to:
manage M pieces of third data that correspond to the M wear management units, respectively, the third data being data into which one or more addresses that respectively indicate one or more access units accessed among the P access units in each of the M wear management units are converted;
access a second access unit among the P access units included in the second wear management unit;
convert a second address indicative of the second access unit into fourth data;
determine whether or not the managed M pieces of third data include the third data corresponding to the second wear management unit;
in a case where the managed M pieces of third data include the third data corresponding to the second wear management unit, make a second determination as to whether there is a possibility that the second address is included in the one or more addresses converted into the third data corresponding to the second wear management unit by using the third data corresponding to the second wear management unit and the fourth data;
determine whether or not to increase a degree of wear-out of the second wear management unit, based on a result of the second determination; and
in a case where the managed M pieces of third data do not include the third data corresponding to the second wear management unit, manage the fourth data as the third data corresponding to the second wear management unit, and
M is an integer smaller than Q.

10. The memory system according to claim 9, wherein
the controller is further configured to, in a case where the managed M pieces of third data do not include the third data corresponding to the second wear management unit and M has reached an upper limit of a number of pieces of third data manageable by the controller:
delete any one piece of third data from the M pieces of third data; and
manage the fourth data as the third data corresponding to the second wear management unit.

11. A memory system comprising:
a nonvolatile memory that includes a plurality of access units; and
a controller electrically connected to the nonvolatile memory and configured to:
perform access to the nonvolatile memory for each access unit;
manage a degree of wear-out of the nonvolatile memory for each wear management unit that includes P access units among the plurality of access units; and
manage S addresses respectively indicating S access units accessed among the plurality of access units, wherein
the controller is configured to, in a case where the S addresses include 2^{T} addresses that are included in one wear management unit and are adjacent:
manage (S−2^{T}+1) addresses that include a compressed address and (S−2^{T}) addresses, the compressed address representing the 2^{T} addresses that are compressed, the (S−2^{T}) addresses being obtained by excluding the 2^{T} addresses from the S addresses;
access a first access unit among the plurality of access units;
make a first determination as to whether or not the S addresses include a first address indicative of the first access unit by using the (S−2^{T}+1) addresses; and
determine whether or not to increase a degree of wear-out of a first wear management unit that includes the first access unit, based on a result of the first determination,
a bit length of each of the 2^{T} addresses is same as a bit length of the compressed address,
the compressed address includes T bits that are invalid in the first determination,
P is an integer of two or more,
S is an integer of two or more, and
T is an integer of one or more.

12. The memory system according to claim 11, wherein
the controller is further configured to asynchronously execute both or one of (A) a process of merging the 2^{T} addresses into the compressed addresses and (B) a process of determining whether or not the S addresses include the first address by using the (S-2^{T}+1) addresses.

13. The memory system according to claim 11, wherein
the controller is further configured
to increase the degree of wear-out of the first wear management unit that includes the first access unit in a case where the S addresses include the first address; and
not to increase the degree of wear-out of the first wear management unit that includes the first access unit in a case where the S addresses do not include the first address.

14. The memory system according to claim 11, wherein
the controller is further configured to:
in a case where the S addresses include the first address, manage (A) addresses that are obtained by excluding all addresses in the first wear management unit from the (S−2^{T}+1) addresses and (B) the first address; and
in a case where the S addresses do not include the first address, manage the (S−2^{T}+1) addresses and the first address.

15. The memory system according to claim 11, wherein
the controller is further configured to, in a case where the S addresses do not include 21 addresses that are included in one wear management unit and are adjacent:
access the first access unit;
make a second determination as to whether or not the S addresses include the first address by using the S addresses; and
determine whether or not to increase the degree of wear-out of the first wear management unit that includes the first access unit, based on a result of the second determination.

16. The memory system according to claim 15, wherein
the controller is further configured to, in a case where the S addresses do not include the first address as a result of the second determination as to whether the S addresses include the first address, and S has reached an upper limit of a number of addresses manageable by the controller:
select a second wear management unit from one or more wear management units each including at least one of the S addresses; and
manage (A) addresses obtained by excluding all addresses in the second wear management unit from the S addresses and (B) the first address.

17. The memory system according to claim 11, wherein
the compressed address is represented by a bit string in which T bits are degraded from a least significant bit of a bit string that indicates any one of the 2^{T} addresses.

18. The memory system according to claim 17, wherein
the controller is further configured to:
manage, for the compressed address, information that indicates the wear management unit including the 2^{T} addresses, the compressed address, and the degraded T bits; and
manage, for a second address among the (S−2^{T}) addresses, information that indicates a wear management unit including the second address, the second address, and a fact that a bit string indicative of the second address is not degraded.

19. A control method of a memory system that comprises a nonvolatile memory including a plurality of access units, the control method comprising:
performing access to the nonvolatile memory for each access unit;
managing a degree of wear-out of the nonvolatile memory for each wear management unit that includes P access units among the plurality of access units;
managing Q pieces of first data that correspond to Q wear management units, respectively, the first data being data into which one or more addresses are converted, the one or more addresses respectively indicating one or more access units accessed among the P access units in each of the Q wear management units;
accessing a first access unit among the P access units that are included in a first wear management unit among the Q wear management units;
converting a first address indicative of the first access unit into second data;
making a first determination as to whether there is a possibility that the first address is included in the one or more addresses converted into the first data corresponding to the first wear management unit among the managed Q pieces of first data by using the first data corresponding to the first wear management unit and the second data; and
determining whether or not to increase a degree of wear-out of the first wear management unit, based on a result of the first determination, wherein
a bit length of the first data is same as a bit length of the second data,
P is an integer of two or more, and
Q is an integer of one or more.

20. The control method according to claim 19, wherein
a second wear management unit includes the P access units among the plurality of access units, and is one of M wear management units,
the control method further comprises:
managing M pieces of third data that correspond to the M wear management units, respectively, the third data being data into which one or more addresses that respectively indicate one or more access units accessed among the P access units in each of the M wear management units are converted;
accessing a second access unit among the P access units included in the second wear management unit;
converting a second address indicative of the second access unit into fourth data;
determining whether or not the managed M pieces of third data include the third data corresponding to the second wear management unit;
in a case where the managed M pieces of third data include the third data corresponding to the second wear management unit, making a second determination as to whether there is a possibility that the second address is included in the one or more addresses converted into the third data corresponding to the second wear management unit by using the third data corresponding to the second wear management unit and the fourth data;
determining whether or not to increase a degree of wear-out of the second wear management unit, based on a result of the second determination; and
in a case where the managed M pieces of third data do not include the third data corresponding to the second wear management unit, managing the fourth data as the third data corresponding to the second wear management unit, and
M is an integer smaller than Q.
